(19) United States
(12) Patent Application Publication
(10) Pub. No.: US 2021/0051702 A1
(43) Pub. Date: Feb. 18, 2021

(54) CONFIGURED GRANT UPLINK CONTROL INFORMATION (UCI) MULTIPLEXING FOR NEW RADIO-UNLICENSED (NR-U)

(71) Applicant: QUALCOMM INCORPORATED, San Diego, CA (US)

(72) Inventors: Kapil Bhattad, Bangalore (IN); Ananta Narayanan Thyagarajan, Bangalore (IN); Jing Sun, San Diego, CA (US); Xiaoxia Zhang, San Diego, CA (US); Mostafa Khoshnevisan, San Diego, CA (US)

(21) Appl. No.: 16/899,506

(22) Filed: Jun. 11, 2020

(30) Foreign Application Priority Data
Aug. 13, 2019 (IN) 201941032730
Aug. 28, 2019 (IN) 201941034600

(51) Int. Cl. H04W 72/14; H04W 72/04; H04L 1/18; H04L 5/00; H04W 76/27

(52) U.S. Cl. CPC H04W 72/14; H04W 72/0413; H04W 72/0446; H04L 5/0055; H04W 76/27; H04L 1/1819

(57) ABSTRACT

Wireless communications systems and methods related to communications in a network that supports usage of configured grant uplink control information (CG-UCI) data are provided. A user equipment (UE) may receive a configuration for a configured grant resource and transmit an UL communication signal in the configured grant resource. The UL communication signal may include a CG-UCI multiplexed with UL data. Additionally, the CG-UCI may indicate whether the UL data includes additional UCI.

### CROSS REFERENCE TO RELATED APPLICATIONS & PRIORITY CLAIM

The present application claims priority to and the benefit of the Indian Provisional Patent Application No. 201941032730 filed Aug. 13, 2019, and the Indian Provisional Patent Application No. 201941034600 filed Aug. 28, 2019, which are hereby incorporated by reference in their entirety as if fully set forth below and for all applicable purposes.

### TECHNICAL FIELD

This application relates to wireless communication systems, and more particularly to multiplexing uplink (UL) control information (UCI).

### INTRODUCTION

Wireless communications systems are widely deployed to provide various types of communication content such as voice, video, packet data, messaging, broadcast, and so on. These systems may be capable of supporting communication with multiple users by sharing the available system resources (e.g., time, frequency, and power). A wireless multiple-access communications system may include a number of base stations (BSs), each simultaneously supporting communications for multiple communication devices, which may be otherwise known as user equipment (UE).

To meet the growing demands for expanded mobile broadband connectivity, wireless communication technologies are advancing from the long term evolution (LTE) technology to a next generation new radio (NR) technology. For example, NR is designed to provide a lower latency, a higher bandwidth or a higher throughput, and a higher reliability than LTE. NR is designed to operate over a wide array of spectrum bands, for example, from low-frequency bands below about 1 gigahertz (GHz) and mid-frequency bands from about 1 GHz to about 6 GHz, to high-frequency bands such as millimeter wave (mmWave) bands. NR is also designed to operate across different spectrum types, from licensed spectrum to unlicensed and shared spectrum. Spectrum sharing enables operators to opportunistically aggregate spectrums to dynamically support high-bandwidth services. Spectrum sharing can extend the benefit of NR technologies to operating entities that may not have access to a licensed spectrum.

One approach to avoiding collisions when communicating in a shared spectrum or an unlicensed spectrum is to use a listen-before-talk (LBT) procedure to ensure that the shared channel is clear before transmitting a signal in the shared channel. For example, a transmitting node may listen to the channel to determine whether there are active transmissions in the channel. When the channel is idle, the transmitting node may transmit a preamble to reserve a channel occupancy time (COT) in the shared channel and may communicate with a receiving node during the COT.

### BRIEF SUMMARY OF SOME EXAMPLES

The following summarizes some aspects of the present disclosure to provide a basic understanding of the discussed technology. This summary is not an extensive overview of all contemplated features of the disclosure, and is intended neither to identify key or critical elements of all aspects of the disclosure nor to delineate the scope of any or all aspects of the disclosure. Its sole purpose is to present some concepts of one or more aspects of the disclosure in summary form as a prelude to the more detailed description that is presented later.

For example, in an aspect of the disclosure, a method of wireless communication includes receiving, by a user equipment (UE), a configuration for a configured grant resource; and transmitting, by the UE, an uplink (UL) communication signal in the configured grant resource, the UL communication signal including a configured-grant UL control information (CG-UCI) multiplexed with UL data, and the CG-UCI indicating whether the UL data includes first UCI.

In an additional aspect of the disclosure, a method of wireless communication includes transmitting, by a base station (BS), a configuration for a configured grant resource; and receiving, by the BS, a UL communication signal in the configured grant resource, the UL communication signal including a CG-UCI multiplexed with UL data, and the CG-UCI indicating whether the UL data includes first UCI.

In an additional aspect of the disclosure, a method of wireless communication includes receiving, by a UE, a transmission configuration for a configured grant resource; and transmitting, by the UE, a UL communication signal in the configured grant resource, the UL communication signal including at least one of a scheduled Hybrid Automatic Repeat Request (HARQ) acknowledgment (ACK)/negative-acknowledgement (NACK) or a configured grant transmission.

In an additional aspect of the disclosure, a method of wireless communication includes transmitting, by a BS, a transmission configuration for a configured grant resource; and receiving, by the BS, a UL communication signal in the configured grant resource, the UL communication signal including at least one of a scheduled HARQ ACK/NACK or a configured grant transmission.

In an additional aspect of the disclosure, a method of wireless communication includes receiving, by a UE from a BS, multiplexing configuration information associated with a configured grant resource and HARQ-ACK feedback, the multiplexing configuration information specifying a no-multiplex mode or a multiplex mode; in response to a determination that the multiplexing configuration information specifies the no-multiplex mode for a slot: determining whether to transmit the HARQ-ACK feedback or configured-grant uplink (CG-UL) data in the slot; transmitting the HARQ-ACK feedback in the slot in response to a determination to transmit the HARQ-ACK feedback; and transmitting the CG-UL data in the slot in response to a determination to transmit the CG-UL data; and in response to a determination that the multiplexing configuration information specifies the multiplex mode for the slot, transmitting a UL communication signal in the configured grant resource, the UL communication signal including the CG-UL data multiplexed with the HARQ-ACK feedback.

In an additional aspect of the disclosure, a method of wireless communication includes transmitting, by a BS to a UE, multiplexing configuration information associated with a configured grant resource and HARQ-ACK feedback, the multiplexing configuration information specifying a no-multiplex mode or a multiplex mode; receiving, by the BS, a UL communication signal including the HARQ-ACK feedback or CG-UL data in response to transmitting the multiplexing configuration information specifying the no-multiplex mode; and receiving, by the BS, a UL communication signal including the CG-UL data multiplexed with the HARQ-ACK feedback in response to transmitting the multiplexing configuration information specifying the multiplex mode.

In an additional aspect of the disclosure, a method of wireless communication includes receiving, by a UE, a configuration providing a plurality of starting offsets to use for configured grant transmissions; selecting, by the UE, a starting offset from the plurality of starting offsets for transmitting a UL communication signal in a configured grant resource; determining, by the UE, a set of resource elements (REs) for multiplexing UCI in the configured grant resource based on the plurality of starting offsets or the selected starting offset; and transmitting, by the UE, the UL communication signal based on the configuration if listen-before-talk (LBT) passes at the selected starting offset.

In an additional aspect of the disclosure, a method of wireless communication includes configuring, by a BS, a plurality of starting offsets for transmission of a UL communication signal in a configured grant resource; configuring, by a BS, a plurality of starting offsets for transmission of a UL communication signal in a configured grant resource; and receiving, by the BS, the UL communication signal based on the configuration.

In an additional aspect of the disclosure, an apparatus includes a transceiver configured to: receive a configuration for a configured grant resource; and transmit a UL communication signal in the configured grant resource, the UL communication signal including a CG-UCI multiplexed with UL data, and the CG-UCI indicating whether the UL data includes first UCI.

In an additional aspect of the disclosure, an apparatus includes a transceiver configured to: transmit a configuration for a configured grant resource; and receive a UL communication signal in the configured grant resource, wherein the UL communication signal includes a CG-UCI multiplexed with UL data, and wherein the CG-UCI indicates whether the UL data includes first UCI.

In an additional aspect of the disclosure, an apparatus includes a transceiver configured to: receive a transmission configuration for a configured grant resource; and transmit a UL communication signal in the configured grant resource, wherein the UL communication signal includes at least one of a scheduled HARQ ACK/NACK or a configured grant transmission.

In an additional aspect of the disclosure, an apparatus includes a transceiver configured to: transmit a transmission configuration for a configured grant resource; and receive a UL communication signal in the configured grant resource, the UL communication signal including at least one of a scheduled HARQ ACK/NACK or a configured grant transmission.

In an additional aspect of the disclosure, an apparatus includes a processor configured to: determine whether multiplexing configuration information specifies a no-multiplex mode or a multiplex mode, wherein the multiplexing configuration information is associated with a configured grant resource and HARQ-ACK feedback; and determine whether to transmit the HARQ-ACK feedback or CG-UL data in a slot; and a transceiver configured to: receive from a BS, the multiplexing configuration information; in response to a determination that the multiplexing configuration information specifies the no-multiplex mode for a slot: transmit the HARQ-ACK feedback in the slot in response to a determination to transmit the HARQ-ACK feedback; and transmit the CG-UL data in the slot in response to a determination to transmit the CG-UL data; and in response to a determination that the multiplexing configuration information specifies the multiplex mode for the slot, transmit a UL communication signal in the configured grant resource, wherein the UL communication signal includes the CG-UL data multiplexed with the HARQ-ACK feedback.

In an additional aspect of the disclosure, an apparatus includes a transceiver configured to: transmit to a UE, multiplexing configuration information associated with a configured grant resource and HARQ-ACK feedback, the multiplexing configuration information specifying a no-multiplex mode or a multiplex mode; receive a UL communication signal including the HARQ-ACK feedback or CG-UL data in response to transmitting the multiplexing configuration information specifying the no-multiplex mode; and receive a UL communication signal including the CG-UL data multiplexed with the HARQ-ACK feedback in response to transmitting the multiplexing configuration information specifying the multiplex mode.

In an additional aspect of the disclosure, an apparatus includes a transceiver configured to: receive a configuration providing a plurality of starting offsets to use for configured grant transmissions; and transmit a UL communication signal based on the configuration if LBT passes at a selected starting offset; and a processor configured to: select the starting offset from the plurality of starting offsets for transmitting the UL communication signal in a configured grant resource; and determine a set of REs for multiplexing UCI in the configured grant resource based on the plurality of starting offsets or the selected starting offset.

In an additional aspect of the disclosure, an apparatus includes a processor configured to: configure a plurality of starting offsets for transmission of a UL communication signal in a configured grant resource; and determine a configuration for receiving the UL communication signal in the configured grant resource based on a starting offset of the plurality of starting offsets, wherein the starting offset is based on a result of a LBT procedure performed by a UE; and a transceiver configured to: receive the UL communication signal based on the configuration.

In an additional aspect of the disclosure, a computer-readable medium having program code recorded thereon, the program code includes code for causing a UE to receive a configuration for a configured grant resource; and code for causing the UE to transmit a UL communication signal in the configured grant resource, wherein the UL communication signal includes a CG-UCI multiplexed with UL data, and the CG-UCI indicates whether the UL data includes first UCI.

In an additional aspect of the disclosure, a computer-readable medium having program code recorded thereon, the program code includes code for causing a BS to transmit a configuration for a configured grant resource; and code for causing the BS to receive a UL communication signal in the configured grant resource, wherein the UL communication signal includes a CG-UCI multiplexed with UL data, and the CG-UCI indicates whether the UL data includes first UCI.

In an additional aspect of the disclosure, a computer-readable medium having program code recorded thereon, the program code includes code for causing a UE to receive a transmission configuration for a configured grant resource; and code for causing the UE to transmit a UL communication signal in the configured grant resource, wherein the UL communication signal includes at least one of a scheduled HARQ ACK/NACK or a configured grant transmission.

In an additional aspect of the disclosure, a computer-readable medium having program code recorded thereon, the program code includes code for causing a BS to transmit a transmission configuration for a configured grant resource; and code for causing the BS to receive a UL communication signal in the configured grant resource, wherein the UL communication signal includes at least one of a scheduled HARQ ACK/NACK or a configured grant transmission.

In an additional aspect of the disclosure, a computer-readable medium having program code recorded thereon, the program code includes code for causing a UE to receive from a BS, multiplexing configuration information associated with a configured grant resource and HARQ-ACK feedback, wherein the multiplexing configuration information specifies a no-multiplex mode or a multiplex mode; code for causing the UE to determine whether to transmit the HARQ-ACK feedback or CG-UL data in the slot in response to a determination that the multiplexing configuration information specifies the no-multiplex mode for a slot; code for causing the UE to transmit the HARQ-ACK feedback in the slot in response to a determination that the multiplexing configuration information specifies the no-multiplex mode for the slot and in response to a determination to transmit the HARQ-ACK feedback; code for causing the UE to transmit the CG-UL data in the slot in response to a determination that the multiplexing configuration information specifies the no-multiplex mode for the slot and in response to a determination to transmit the CG-UL data; and code for causing the UE to transmit a UL communication signal in the configured grant resource in response to a determination that the multiplexing configuration information specifies the multiplex mode for the slot, wherein the UL communication signal includes the CG-UL data multiplexed with the HARQ-ACK feedback.

In an additional aspect of the disclosure, a computer-readable medium having program code recorded thereon, the program code includes code for causing a BS to transmit to a UE, multiplexing configuration information associated with a configured grant resource and HARQ-ACK feedback, wherein the multiplexing configuration information specifies a no-multiplex mode or a multiplex mode; and code for causing the BS to receive a UL communication signal including the HARQ-ACK feedback or CG-UL data in response to transmitting the multiplexing configuration information specifying the no-multiplex mode; and code for causing the BS to receive a UL communication signal including the CG-UL data multiplexed with the HARQ-ACK feedback in response to transmitting the multiplexing configuration information specifying the multiplex mode.

In an additional aspect of the disclosure, a computer-readable medium having program code recorded thereon, the program code includes code for causing a UE to receive a configuration providing a plurality of starting offsets to use for configured grant transmissions; code for causing the UE to select a starting offset from the plurality of starting offsets for transmitting a UL communication signal in a configured grant resource; code for causing the UE to determine a set of REs for multiplexing UCI in the configured grant resource based on the plurality of starting offsets or the selected starting offset; and code for causing the UE to transmit the UL communication signal based on the configuration if LBT passes at the selected starting offset.

In an additional aspect of the disclosure, a computer-readable medium having program code recorded thereon, the program code includes code for causing a BS to configure a plurality of starting offsets for transmission of a UL communication signal in a configured grant resource; code for causing the BS to determine a configuration for receiving the UL communication signal in the configured grant resource based on a starting offset of the plurality of starting offsets, the starting offset being based on a result of a LBT procedure performed by a UE; and code for causing the BS to receive the UL communication signal based on the configuration.

In an additional aspect of the disclosure, an apparatus includes means for receiving from a BS, a configuration for a configured grant resource; and means for transmitting to the BS, a UL communication signal in the configured grant resource, wherein the UL communication signal includes a CG-UCI multiplexed with UL data, and the CG-UCI indicates whether the UL data includes first UCI.

In an additional aspect of the disclosure, an apparatus includes means for transmitting to a UE, a configuration for a configured grant resource; and means for receiving from the UE, a UL communication signal in the configured grant resource, wherein the UL communication signal includes a CG-UCI multiplexed with UL data, and the CG-UCI indicates whether the UL data includes first UCI.

In an additional aspect of the disclosure, an apparatus includes means for receiving from a BS a transmission configuration for a configured grant resource; and means for transmitting to the BS, a UL communication signal in the configured grant resource, wherein the UL communication signal includes at least one of a scheduled HARQ ACK/NACK or a configured grant transmission.

In an additional aspect of the disclosure, an apparatus includes means for transmitting to a UE, a transmission configuration for a configured grant resource; and means for receiving from the UE, a UL communication signal in the configured grant resource, wherein the UL communication signal includes at least one of a scheduled HARQ ACK/NACK or a configured grant transmission.

In an additional aspect of the disclosure, an apparatus includes means for receiving from a BS, multiplexing configuration information associated with a configured grant resource and HARQ-ACK feedback, wherein the multiplexing configuration information specifies a no-multiplex mode or a multiplex mode; in response to a determination that the multiplexing configuration information specifies the no-multiplex mode for a slot: means for determining whether to transmit the HARQ-ACK feedback or CG-UL data in the slot; means for transmitting the HARQ-ACK feedback in the slot in response to a determination to transmit the HARQ-ACK feedback; and means for transmitting the CG-UL data in the slot in response to a determination to transmit the CG-UL data; and means for transmitting a UL communication signal in the configured grant resource in response to a determination that the multiplexing configuration information specifies the multiplex mode for the slot, wherein the UL communication signal includes the CG-UL data multiplexed with the HARQ-ACK feedback.

In an additional aspect of the disclosure, an apparatus includes means for transmitting multiplexing configuration information associated with a configured grant resource and HARQ-ACK feedback, wherein the multiplexing configuration information specifies a no-multiplex mode or a multiplex mode; means for receiving a UL communication signal including the HARQ-ACK feedback or CG-UL data in response to transmitting the multiplexing configuration information specifying the no-multiplex mode; and means for receiving a UL communication signal including the CG-UL data multiplexed with the HARQ-ACK feedback in response to transmitting the multiplexing configuration information specifying the multiplex mode.

In an additional aspect of the disclosure, an apparatus includes means for receiving a configuration providing a plurality of starting offsets to use for configured grant transmissions; means for selecting a starting offset from the plurality of starting offsets for transmitting a UL communication signal in a configured grant resource; means for determining a set of REs for multiplexing UCI in the configured grant resource based on the plurality of starting offsets or the selected starting offset; and means for transmitting the UL communication signal based on the configuration if LBT passes at the selected starting offset.

In an additional aspect of the disclosure, an apparatus includes means for configuring a plurality of starting offsets for transmission of a UL communication signal in a configured grant resource; means for determining a configuration for receiving the UL communication signal in the configured grant resource based on a starting offset of the plurality of starting offsets, the starting offset being based on a result of a LBT procedure performed by a UE; and means for receiving the UL communication signal based on the configuration

Other aspects, features, and embodiments of the present disclosure will become apparent to those of ordinary skill in the art, upon reviewing the following description of specific, exemplary embodiments of the present disclosure in conjunction with the accompanying figures. While features of the present disclosure may be discussed relative to certain embodiments and figures below, all embodiments of the present disclosure can include one or more of the advantageous features discussed herein. In other words, while one or more embodiments may be discussed as having certain advantageous features, one or more of such features may also be used in accordance with the various embodiments of the disclosure discussed herein. In similar fashion, while exemplary embodiments may be discussed below as device, system, or method embodiments it should be understood that such exemplary embodiments can be implemented in various devices, systems, and methods.

### BRIEF DESCRIPTION OF THE DRAWINGS

FIG. 1 illustrates a wireless communication network according to one or more embodiments of the present disclosure.

FIG. 2 illustrates a scheduling/configuration timeline according to embodiments of the present disclosure.

FIG. 3 is a timing diagram illustrating a transmission frame structure according to some embodiments of the present disclosure.

FIG. 4 illustrates a communication scheme for multiplexing configured grant uplink control information (CG-UCI), at least one normal uplink control information (UCI), and/or uplink (UL) data according to some embodiments of the present disclosure.

FIG. 5 illustrates a communication scheme for transmitting scheduled UCI in a configured UL resource according to some embodiments of the present disclosure.

FIG. 6 illustrates a communication scheme for multiplexing CG-UCI with CG-UL data according to some embodiments of the present disclosure.

FIG. 7 illustrates a communication scheme for multiplexing scheduled UCI with CG-UL data according to some embodiments of the present disclosure.

FIG. 8 illustrates a communication scheme for multiplexing CG-UCI and Hybrid Automatic Repeat Request (HARQ)-acknowledgment (ACK) according to some embodiments of the present disclosure.

FIG. 9 is a timing diagram illustrating multiplexing of UCI with multiple starting offsets in a transmission scheme according to some embodiments of the present disclosure.

FIG. 10 is a block diagram of a user equipment (UE) according to some embodiments of the present disclosure.

FIG. 11 is a block diagram of an exemplary base station (BS) according to some embodiments of the present disclosure.

FIG. 12 is a flow diagram of a communication method according to some embodiments of the present disclosure.

FIG. 13 is a flow diagram of a communication method according to some embodiments of the present disclosure.

FIG. 14 is a flow diagram of a communication method according to some embodiments of the present disclosure.

FIG. 15 is a flow diagram of a communication method according to some embodiments of the present disclosure.

FIG. 16 is a flow diagram of a communication method according to some embodiments of the present disclosure.

FIG. 17 is a flow diagram of a communication method according to some embodiments of the present disclosure.

FIG. 18 is a flow diagram of a communication method according to some embodiments of the present disclosure.

FIG. 19 is a flow diagram of a communication method according to some embodiments of the present disclosure.

### DETAILED DESCRIPTION

The detailed description set forth below, in connection with the appended drawings, is intended as a description of various configurations and is not intended to represent the only configurations in which the concepts described herein may be practiced. The detailed description includes specific details for the purpose of providing a thorough understanding of the various concepts. However, it will be apparent to those skilled in the art that these concepts may be practiced without these specific details. In some instances, well-known structures and components are shown in block diagram form in order to avoid obscuring such concepts.

This disclosure relates generally to wireless communications systems, also referred to as wireless communications networks. In various embodiments, the techniques and apparatus may be used for wireless communication networks such as code division multiple access (CDMA) networks, time division multiple access (TDMA) networks, frequency division multiple access (FDMA) networks, orthogonal FDMA (OFDMA) networks, single-carrier FDMA (SC-FDMA) networks, LTE networks, Global System for Mobile Communications (GSM) networks, 5^{th} Generation (5G) or new radio (NR) networks, as well as other communications networks. As described herein, the terms “networks” and “systems” may be used interchangeably.

An OFDMA network may implement a radio technology such as evolved UTRA (E-UTRA), Institute of Electrical and Electronics Engineers (IEEE) 802.11, IEEE 802.16, IEEE 802.20, flash-OFDM and the like. UTRA, E-UTRA, and GSM are part of universal mobile telecommunication system (UMTS). In particular, long term evolution (LTE) is a release of UMTS that uses E-UTRA. UTRA, E-UTRA, GSM, UMTS and LTE are described in documents provided from an organization named “3rd Generation Partnership Project” (3GPP), and cdma2000 is described in documents from an organization named “3rd Generation Partnership Project 2” (3GPP2). These various radio technologies and standards are known or are being developed. For example, the 3rd Generation Partnership Project (3GPP) is a collaboration between groups of telecommunications associations that aims to define a globally applicable third generation (3G) mobile phone specification. 3GPP long term evolution (LTE) is a 3GPP project which was aimed at improving the UMTS mobile phone standard. The 3GPP may define specifications for the next generation of mobile networks, mobile systems, and mobile devices. The present disclosure is concerned with the evolution of wireless technologies from LTE, 4G, 5G, NR, and beyond with shared access to wireless spectrum between networks using a collection of new and different radio access technologies or radio air interfaces.

In particular, 5G networks contemplate diverse deployments, diverse spectrum, and diverse services and devices that may be implemented using an OFDM-based unified, air interface. In order to achieve these goals, further enhancements to LTE and LTE-A are considered in addition to development of the new radio technology for 5G NR networks. The 5G NR will be capable of scaling to provide coverage (1) to a massive Internet of things (IoTs) with a ULtra-high density (e.g., ˜1M nodes/km²), ultra-low complexity (e.g., ˜10s of bits/sec), ultra-low energy (e.g., ˜10+ years of battery life), and deep coverage with the capability to reach challenging locations; (2) including mission-critical control with strong security to safeguard sensitive personal, financial, or classified information, ultra-high reliability (e.g., ˜99.9999% reliability), ultra-low latency (e.g., ˜1 millisecond (ms)), and users with wide ranges of mobility or lack thereof; and (3) with enhanced mobile broadband including extreme high capacity (e.g., ˜10 Tbps/km²), extreme data rates (e.g., multi-Gbps rate, 100+ Mbps user experienced rates), and deep awareness with advanced discovery and optimizations.

The 5G NR may be implemented to use optimized OFDM-based waveforms with scalable numerology and transmission time interval (TTI); having a common, flexible framework to efficiently multiplex services and features with a dynamic, low-latency time division duplex (TDD)/frequency division duplex (FDD) design; and with advanced wireless technologies, such as massive multiple input, multiple output (MIMO), robust millimeter wave (mmWave) transmissions, advanced channel coding, and device-centric mobility. Scalability of the numerology in 5G NR, with scaling of subcarrier spacing, may efficiently address operating diverse services across diverse spectrum and diverse deployments. For example, in various outdoor and macro coverage deployments of less than 3GHz FDD/TDD implementations, subcarrier spacing may occur with 15 kHz, for example over 5, 10, 20 MHz, and the like bandwidth (BW). For other various outdoor and small cell coverage deployments of TDD greater than 3 GHz, subcarrier spacing may occur with 30 kHz over 80/100 MHz BW. For other various indoor wideband implementations, using a TDD over the unlicensed portion of the 5 GHz band, the subcarrier spacing may occur with 60 kHz over a 160 MHz BW. Finally, for various deployments transmitting with mmWave components at a TDD of 28 GHz, subcarrier spacing may occur with 120 kHz over a 500 MHz BW.

The scalable numerology of the 5G NR facilitates scalable TTI for diverse latency and quality of service (QoS) requirements. For example, shorter TTI may be used for low latency and high reliability, while longer TTI may be used for higher spectral efficiency. The efficient multiplexing of long and short TTIs to allow transmissions to start on symbol boundaries. 5G NR also contemplates a self-contained integrated subframe design with uplink/downlink scheduling information, data, and acknowledgement in the same subframe. The self-contained integrated subframe supports communications in unlicensed or contention-based shared spectrum, adaptive uplink/downlink that may be flexibly configured on a per-cell basis to dynamically switch between uplink and downlink to meet the current traffic needs.

Various other aspects and features of the disclosure are further described below. It should be apparent that the teachings herein may be embodied in a wide variety of forms and that any specific structure, function, or both being disclosed herein is merely representative and not limiting. Based on the teachings herein one of an ordinary level of skill in the art should appreciate that an aspect disclosed herein may be implemented independently of any other aspects and that two or more of these aspects may be combined in various ways. For example, an apparatus may be implemented or a method may be practiced using any number of the aspects set forth herein. In addition, such an apparatus may be implemented or such a method may be practiced using other structure, functionality, or structure and functionality in addition to or other than one or more of the aspects set forth herein. For example, a method may be implemented as part of a system, device, apparatus, and/or as instructions stored on a computer readable medium for execution on a processor or computer. Furthermore, an aspect may comprise at least one element of a claim.

In an embodiment, the network 100 may operate over shared frequency bands or unlicensed frequency bands, for example, at about 3.5 gigahertz (GHz), sub-6 GHz or higher frequencies in the mmWav band. Operations in unlicensed spectrum may include DL transmissions and/or UL transmissions. A UL transmission (e.g., autonomous UL via a dynamic UL grant or scheduled UL transmission via a configured UL grant) in the licensed frequency band may occur under various circumstances. A grantless or grant-free uplink transmission is an unscheduled transmission, performed on the channel without an UL grant.

The present application describes mechanisms for transmission of uplink (UL) control information (UCI) and multiplexing UCI. UCI may include a configured grant UCI (CG-UCI) and/or normal UCI. The normal UCI may include an ACK/NACK, channel state information (CSI), and/or a scheduling request (SR). In physical uplink shared channel (PUSCH), the CG-UCI may be multiplexed along with configured-UL data, which may refer to unscheduled UL data. Configured-UL data will be discussed in further detail below. Normal UCI may additionally be multiplexed with the configured UL PUSCH.

In some examples, a UE operating in a shared or unlicensed frequency spectrum may perform a listen-before-talk (LBT) procedure (e.g., clear channel assessment (CCA)) prior to communicating in order to determine whether the channel is available. If the channel is available, the UE acquires the channel and performs a UL transmission (e.g., autonomous UL or scheduled UL transmission) in the channel. If the channel is not available, the UE may perform a back off procedure and perform the LBT procedure again at a later point in time.

A BS may schedule a UE for UL and/or DL communications. For example, the UE may transmit a UL data signal via a scheduled UL grant. Additionally, the UE may receive a DL data signal via a scheduled DL grant. In some examples, rather than wait for a UL grant, the UE may transmit a UL communication signal in a configured grant resource. The BS may allocate configured grant resources in an unlicensed frequency band for UL or DL transmission. The UL communication signal may include the CG-UCI multiplexed with normal UCI and/or configured-UL data. The CG-UCI may indicate information associated with at least one of UCI or UL data. In an example, the UE may transmit the CG-UCI such that it is decoded first by the BS. The CG-UCI is related to the transmissions within the configured grant resource and can enable robust decoding of the other normal UCIs.

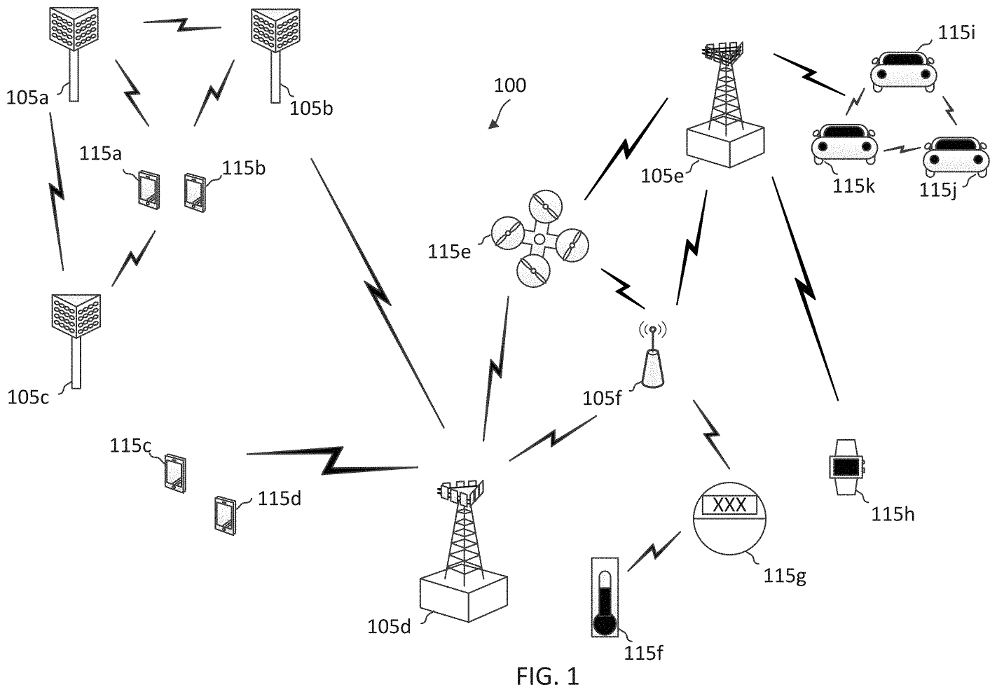

FIG. 1 illustrates a wireless communication network 100 according to some embodiments of the present disclosure. The network 100 may be a 5G network. The network 100 includes a number of base stations (BSs) 105 (individually labeled as 105a, 105b, 105c, 105d, 105e, and 105f) and other network entities. A BS 105 may be a station that communicates with UEs 115 and may also be referred to as an evolved node B (eNB), a next generation eNB (gNB), an access point, and the like. Each BS 105 may provide communication coverage for a particular geographic area. In 3GPP, the term “cell” can refer to this particular geographic coverage area of a BS 105 and/or a BS subsystem serving the coverage area, depending on the context in which the term is used.

A BS 105 may provide communication coverage for a macro cell or a small cell, such as a pico cell or a femto cell, and/or other types of cell. A macro cell generally covers a relatively large geographic area (e.g., several kilometers in radius) and may allow unrestricted access by UEs with service subscriptions with the network provider. A small cell, such as a pico cell, would generally cover a relatively smaller geographic area and may allow unrestricted access by UEs with service subscriptions with the network provider. A small cell, such as a femto cell, would also generally cover a relatively small geographic area (e.g., a home) and, in addition to unrestricted access, may also provide restricted access by UEs having an association with the femto cell (e.g., UEs in a closed subscriber group (CSG), UEs for users in the home, and the like). A BS for a macro cell may be referred to as a macro BS. A BS for a small cell may be referred to as a small cell BS, a pico BS, a femto BS or a home BS. In the example shown in FIG. 1, the BSs 105d and 105e may be regular macro BSs, while the BSs 105a-105c may be macro BSs enabled with one of three dimension (3D), full dimension (FD), or massive MIMO. The BSs 105a-105c may take advantage of their higher dimension MIMO capabilities to exploit 3D beamforming in both elevation and azimuth beamforming to increase coverage and capacity. The BS 105f may be a small cell BS which may be a home node or portable access point. A BS 105 may support one or multiple (e.g., two, three, four, and the like) cells.

The network 100 may support synchronous or asynchronous operation. For synchronous operation, the BSs may have similar frame timing, and transmissions from different BSs may be approximately aligned in time. For asynchronous operation, the BSs may have different frame timing, and transmissions from different BSs may not be aligned in time.

The UEs 115 are dispersed throughout the wireless network 100, and each UE 115 may be stationary or mobile. A UE 115 may also be referred to as a terminal, a mobile station, a subscriber unit, a station, or the like. A UE 115 may be a cellular phone, a personal digital assistant (PDA), a wireless modem, a wireless communication device, a handheld device, a tablet computer, a laptop computer, a cordless phone, a wireless local loop (WLL) station, or the like. In one aspect, a UE 115 may be a device that includes a Universal Integrated Circuit Card (UICC). In another aspect, a UE may be a device that does not include a UICC. In some aspects, the UEs 115 that do not include UICCs may also be referred to as IoT devices or internet of everything (IoE) devices. The UEs 115a-115d are examples of mobile smart phone-type devices accessing network 100. A UE 115 may also be a machine specifically configured for connected communication, including machine type communication (MTC), enhanced MTC (eMTC), narrowband IoT (NB-IoT) and the like. The UEs 115e-115k are examples of various machines configured for communication that access the network 100. A UE 115 may be able to communicate with any type of the BSs, whether macro BS, small cell, or the like. In FIG. 1, a lightning bolt (e.g., communication links) indicates wireless transmissions between a UE 115 and a serving BS 105, which is a BS designated to serve the UE 115 on the downlink and/or uplink, or desired transmission between BSs, and backhaul transmissions between BSs.

In operation, the BSs 105a-105c may serve the UEs 115a and 115b using 3D beamforming and coordinated spatial techniques, such as coordinated multipoint (CoMP) or multi-connectivity. The macro BS 105d may perform backhaul communications with the BSs 105a-105c, as well as small cell, the BS 105f. The macro BS 105d may also transmits multicast services which are subscribed to and received by the UEs 115c and 115d. Such multicast services may include mobile television or stream video, or may include other services for providing community information, such as weather emergencies or alerts, such as Amber alerts or gray alerts.

The BSs 105 may also communicate with a core network. The core network may provide user authentication, access authorization, tracking, Internet Protocol (IP) connectivity, and other access, routing, or mobility functions. At least some of the BSs 105 (e.g., which may be an example of a gNB or an access node controller (ANC)) may interface with the core network through backhaul links (e.g., NG-C, NG-U, etc.) and may perform radio configuration and scheduling for communication with the UEs 115. In various examples, the BSs 105 may communicate, either directly or indirectly (e.g., through core network), with each other over backhaul links (e.g., X1, X2, etc.), which may be wired or wireless communication links.

The network 100 may also support mission critical communications with ultra-reliable and redundant links for mission critical devices, such as the UE 115e, which may be a drone. Redundant communication links with the UE 115e may include links from the macro BSs 105d and 105e, as well as links from the small cell BS 105f. Other machine type devices, such as the UE 115f (e.g., a thermometer), the UE 115g (e.g., smart meter), and UE 115h (e.g., wearable device) may communicate through the network 100 either directly with BSs, such as the small cell BS 105f, and the macro BS 105e, or in multi-hop configurations by communicating with another user device which relays its information to the network, such as the UE 115f communicating temperature measurement information to the smart meter, the UE 115g, which is then reported to the network through the small cell BS 105f. The network 100 may also provide additional network efficiency through dynamic, low-latency TDD/FDD communications, such as in a vehicle-to-vehicle (V2V).

In some implementations, the network 100 utilizes OFDM-based waveforms for communications. An OFDM-based system may partition the system BW into multiple (K) orthogonal subcarriers, which are also commonly referred to as subcarriers, tones, bins, or the like. Each subcarrier may be modulated with data. In some instances, the subcarrier spacing between adjacent subcarriers may be fixed, and the total number of subcarriers (K) may be dependent on the system BW. The system BW may also be partitioned into subbands. In other instances, the subcarrier spacing and/or the duration of TTIs may be scalable.

In an embodiment, the BSs 105 can assign or schedule transmission resources (e.g., in the form of time-frequency resource blocks (RB)) for downlink (DL) and uplink (UL) transmissions in the network 100. DL refers to the transmission direction from a BS 105 to a UE 115, whereas UL refers to the transmission direction from a UE 115 to a BS 105. The communication can be in the form of radio frames. A radio frame may be divided into a plurality of subframes or slots, for example, about 10. Each slot may be further divided into mini-slots. In a FDD mode, simultaneous UL and DL transmissions may occur in different frequency bands. For example, each subframe includes a UL subframe in a UL frequency band and a DL subframe in a DL frequency band. In a TDD mode, UL and DL transmissions occur at different time periods using the same frequency band. For example, a subset of the subframes (e.g., DL subframes) in a radio frame may be used for DL transmissions and another subset of the subframes (e.g., UL subframes) in the radio frame may be used for UL transmissions.

The DL subframes and the UL subframes can be further divided into several regions. For example, each DL or UL subframe may have pre-defined regions for transmissions of reference signals, control information, and data. Reference signals are predetermined signals that facilitate the communications between the BSs 105 and the UEs 115. For example, a reference signal can have a particular pilot pattern or structure, where pilot tones may span across an operational BW or frequency band, each positioned at a pre-defined time and a pre-defined frequency. For example, a BS 105 may transmit cell specific reference signals (CRSs) and/or channel state information-reference signals (CSI-RSs) to enable a UE 115 to estimate a DL channel. Similarly, a UE 115 may transmit sounding reference signals (SRSs) to enable a BS 105 to estimate a UL channel. Control information may include resource assignments and protocol controls. Data may include protocol data and/or operational data. In some embodiments, the BSs 105 and the UEs 115 may communicate using self-contained subframes. A self-contained subframe may include a portion for DL communication and a portion for UL communication. A self-contained subframe can be DL-centric or UL-centric. A DL-centric subframe may include a longer duration for DL communication than for UL communication. A UL-centric subframe may include a longer duration for UL communication than for DL communication.

In an embodiment, the network 100 may be an NR network deployed over a licensed spectrum. The BSs 105 can transmit synchronization signals (e.g., including a primary synchronization signal (PSS) and a secondary synchronization signal (SSS)) in the network 100 to facilitate synchronization. The BSs 105 can broadcast system information associated with the network 100 (e.g., including a master information block (MIB), remaining system information (RMSI), and other system information (OSI)) to facilitate initial network access. In some instances, the BSs 105 may broadcast the PSS, the SSS, and/or the MIB in the form of synchronization signal block (SSBs) over a physical broadcast channel (PBCH) and may broadcast the RMSI and/or the OSI over a physical downlink shared channel (PDSCH).

In an embodiment, a UE 115 attempting to access the network 100 may perform an initial cell search by detecting a PSS from a BS 105. The PSS may enable synchronization of period timing and may indicate a physical layer identity value. The UE 115 may then receive a SSS. The SSS may enable radio frame synchronization, and may provide a cell identity value, which may be combined with the physical layer identity value to identify the cell. The SSS may also enable detection of a duplexing mode and a cyclic prefix length. Some systems, such as TDD systems, may transmit an SSS but not a PSS. Both the PSS and the SSS may be located in a central portion of a carrier, respectively.

After receiving the PSS and SSS, the UE 115 may receive a MIB. The MIB may include system information for initial network access and scheduling information for RMSI and/or OSI. After decoding the MIB, the UE 115 may receive RMSI and/or OSI. The RMSI and/or OSI may include radio resource control (RRC) information related to random access channel (RACH) procedures, paging, control resource set (CORESET) for physical downlink control channel (PDCCH) monitoring, physical uplink control channel (PUCCH), PUSCH, power control, SRS, and cell barring.

After obtaining the MIB, the RMSI and/or the OSI, the UE 115 can perform a random access procedure to establish a connection with the BS 105. After establishing the connection, the UE 115 and the BS 105 can enter a normal operation stage, where operational data may be exchanged. For example, the BS 105 may schedule the UE 115 for UL and/or DL communications. The BS 105 may transmit UL and/or DL scheduling grants to the UE 115 via a PDCCH. The BS 105 may transmit a DL communication signal to the UE 115 via a PDSCH according to a DL scheduling grant. The UE 115 may transmit a UL communication signal to the BS 105 via a PUSCH and/or PUCCH according to a UL scheduling grant. The connection may be referred to as an RRC connection. When the UE 115 is actively exchanging data with the BS 105, the UE 115 is in an RRC connected state.

In an embodiment, the network 100 may operate over a shared frequency band or an unlicensed frequency band, for example, at about 3.5 gigahertz (GHz), sub-6 GHz or higher frequencies in the mmWave band. The network 100 may partition a frequency band into multiple channels, for example, each occupying about 20 megahertz (MHz). The BSs 105 and the UEs 115 may be operated by multiple network operating entities sharing resources in the shared communication medium and may employ a LBT procedure to acquire channel occupancy time (COT) in the share medium for communications. A COT may be non-continuous in time and may refer to an amount of time a station can send frames when it has won contention for the wireless medium. Each COT may include a plurality of slots. The BS 105 or the UE 115 may perform an LBT in the frequency band prior to transmitting in the frequency band. A COT may also be referred to as a transmission opportunity (TXOP).

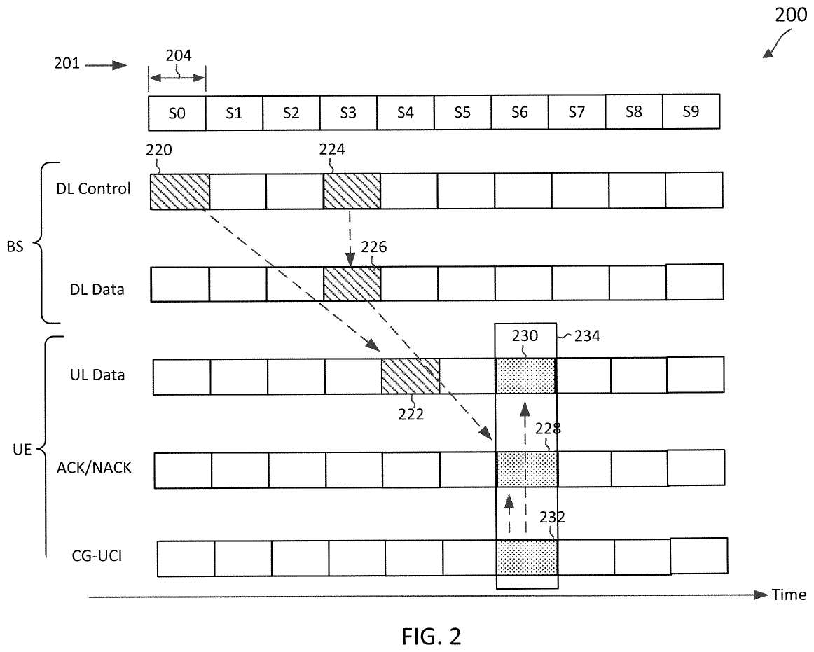

FIG. 2 illustrates a scheduling/configuration timeline 200 according to embodiments of the present disclosure. The scheduling/configuration timeline 200 may correspond to a scheduling/configuration timeline communicated between a BS 105 and a UE 115 of the network 100. In FIG. 2, the x-axis represents time in some constant units. FIG. 2 shows a frame structure 201 including a plurality of slots 204 in time. The slots 204 are indexed from S0 to S9. For example, a BS may communicate with a UE in units of slots 204. The slots 204 may also be referred to as transmission time intervals (TTIs). Each slot 204 or TTI carry a medium access control (MAC) layer transport block. Each slot 204 may include a number of symbols in time and a number of frequency tones in frequency. Each slot 204 may include a DL control portion followed by at least one of a subsequent DL data portion, UL data portion, and/or a UL control portion. In the context of LTE, the DL control portion, the DL data portion, the UL data portion, and the UL control portion may be referred to as a physical downlink control channel (PDCCH), a physical downlink shared channel (PDSCH), a physical uplink shared channel (PUSCH), and a physical uplink control channel (PUCCH), respectively.

The pattern-filled boxes represent transmissions of DL control information (DCI), DL data, UL data, an ACK, and/or an NACK in corresponding slots 204. While an entire slot 204 is pattern-filled, a transmission may occur only in a corresponding portion of the slot 204. As shown, the BS transmits DCI 220 in the slot 204 indexed S0 (e.g., in a DL control portion of the slot 204). The DCI 220 may indicate a UL grant for the UE. The UE transmits a UL data signal 222 to the BS in the slot 204 indexed S4 (e.g., in a UL data portion of the slot 204) based on the UL assignment. The slot 204 indexed S4 is a fourth slot from the slot 204 indexed S0. The UL data signal 222 is a scheduled UL, which is granted by a UL grant indicated in the DCI 220.

Further, the BS transmits DCI 224 in the slot 204 indexed S3 (e.g., in a DL control portion of the slot 204). The DCI 224 may indicate a DL grant for the UE in the same slot 204 indexed S3. Thus, the BS transmits a DL data signal 226 to the UE in the slot 204 indexed S3 (e.g., in a DL data portion of the slot 204). The UE may receive the DCI 224 and receive the DL data signal 226 based on the DL grant. The DL data signal 226 is a scheduled DL, which is granted by a DL grant indicated in the DCI 224.

After receiving the DL data signal 226, the UE 115 may report a reception status of the DL data signal 226 to the BS by transmitting an acknowledgement (ACK)/negative-acknowledgement (NACK) signal 228. The ACK/NACK signal 228 refers to a feedback signal carrying an ACK or an NACK. The feedback may be an acknowledgement (ACK) indicating that reception of the DL data by the UE is successful or may be a negative-acknowledgement (NACK) indicating that reception of the DL data by the UE is unsuccessful (e.g., including an error or failing an error correction). The ACK/NACK signal 228 may be associated with a hybrid automatic repeat request (HARQ) process. In a HARQ process, a transmitting node may transmit various coded versions of information data to a receiving node. For example, the transmitting node may transmit a first coded version of information data to the receiving node. Upon receiving an NACK signal from the receiving node, the transmitting node may transmit a second coded version of the information data to the receiving node. The receiving node may combine the received first coded version and the received second coded version for error correction when both the received first coded version and the received second coded version are erroneous.

Additionally, the UE may implement multiple parallel HARQ processes for UL communications. The HARQ processes may be independent from each other, and each HARQ process may be identified by a HARQ identifier. The UE may maintain and track ACK/NACKs for each process separately. The UE may indicate to the BS whether a data transmission includes a new data or a retransmitted data. For example, the UE may toggle a new data indicator (NDI) to indicate a new data packet and not toggle the NDI to indicate a retransmitted packet.

Transmission of data may be an autonomous (i.e., unscheduled) transmission or a scheduled transmission. As discussed above, the UE transmits the UL data signal 222 via a scheduled UL grant (e.g., transmission in PDCCH via DCI 220). Additionally, the UE receives the DL data signal 226 via a scheduled grant (e.g., transmission in PDCCH via DCI indicated in the DCI 224). A configured UL transmission is an unscheduled transmission, performed on the channel without a UL grant. A configured UL transmission may also be referred to as a grantless, grant-free, or autonomous transmission. In some examples, the UE may transmit a UL resource via a configured grant. Additionally, configured-UL data may also be referred to as grantless UL data, grant-free UL data, unscheduled UL data, or autonomous UL (AUL) data. Additionally, a configured grant may also be referred to as a grant-free grant, unscheduled grant, or autonomous grant. The resources and other parameters used by the UE for a configured grant transmission may be provided by the BS in one or more of a RRC configuration or an activation DCI, without an explicit grant for each UE transmission.

In some examples, the UE transmits a UL communication signal 230 in a configured grant resource 234. The UL communication signal 230 may include UL control information (UCI), a demodulation reference signal (DMRS), a phase-tracking reference signal (PTRS) (not shown), and UL data, which may also be referred to as configured-UL data. The UCI may include, for example, a configured grant UCI (CG-UCI) 232 and normal UCI. Although in FIG. 2, the ACK/NACK signal 228 and the CG-UCI 232 is shown as being separate from the UL communication signal 230, it should be understood that the ACK/NACK signal 228 and/or the CG-UCI 232 may be included in the UL communication signal 230.

The normal UCI may include an ACK/NACK (e.g., ACK/NAK signal 228), channel state information (CSI), and/or a scheduling request (SR). The CSI may include a CSI-part 1 and a CSI-part 2. The CSI-part 1 and the CSI-part 2 can include information related to CSI-RS resource indicator (CRI), rank indicator (RI), layer indicator (LI), wideband channel quality indicator (CQI), and/or subband differential CQI, and/or precoding matrix indicator (PMI), determined based on a reference signal (e.g., a CSI-RS) in a DL communication. Each of the normal UCI (e.g. ACK/NACK, CSI-part1, CSI-part2) may be coded independently. The CG-UCI 232 is related to the configured grant and indicates information associated with the normal UCI (e.g., ACK/NACK, the CSI, and the SR) and/or the configured-UL data (e.g., UL data signal 222). The CG-UCI 232 will be discussed in more detail below.

The DMRS may include pilot symbols distributed across the frequency channel to enable the UE or the BS to perform channel estimation and demodulation for the decoding. The pilot symbols may be generated from a predetermined sequence with a certain pattern, and the remaining symbols may carry UL data. The system can beamform the DMRS, keep it within a scheduled resource, and/or transmit the DMRS only when necessary in either a DL or a UL channel. For example, the DMRS allows a receiver to determine a channel estimate for the frequency channel, where the channel estimate may be used to recover the UL data. Additionally, the PTRS tracks phase of the Local Oscillator at the transmitter and the receiver and accordingly, minimizes the effect of the oscillator phase noise on system performance.

To avoid collisions when communicating in a shared or an unlicensed spectrum, the UE may perform LBT to ensure that the shared channel is clear before transmitting a signal in the shared channel. In an example, if the channel is available (performance of the LBT results in a LBT pass), the UE may perform a UL transmission. If the channel is not available (performance of the LBT results in a LBT fail), the UE may back off and perform the LBT procedure again at a later point in time. Accordingly, based on the LBT, the UE may not be able to acquire a COT due to other operators operating on the shared channel. The UE's ability to transmit on the UL transmission depends on whether the UE is able to gain access to the medium for transmission and/or reception of data. Rather than wait for a UL grant, the UE may desire to transmit a UL communication signal in a configured grant resource.

Additionally, to support more resource allocations in a network, transmissions may be scheduled based on a semi-persistent schedule (SPS). The BS may allocate configured grant resources in an unlicensed frequency band for UL or DL transmission. In some examples, the configured grant resource 234 is based on a SPS. After a LBT results in a LBT pass, the BS may perform LBT and acquire a COT during which the BS transmits a SPS to a group of UEs. The BS may transmit to the UE, a configuration for a configured grant resource (e.g., configured grant resource 234). The BS may transmit the SPS, for example, via a RRC configuration message. The RRC configuration message may configure the UE with semi-persistent resources for AUL transmissions. In some examples, the UE-specific RRC signaling configures and/or reconfigures the location of the PUSCH for UCI transmission. The SPS includes a plurality of resource allocations spaced apart in time. The plurality of resource allocations may be spaced apart in time in accordance with a time interval of, for example, about 40 ms. In this example, the plurality of resources is allocated every 40 ms for each UE in the group of UEs. A resource may be shared with the group of UEs, and a UE may contend for the resource. The SPS may indicate scheduling information using relative timing (e.g., an offset time period relative to a current time period in which the scheduling information is communicated). The BS may receive the UL communication signal 230 in the configured grant resource 234, using a resource allocation specified in the SPS.

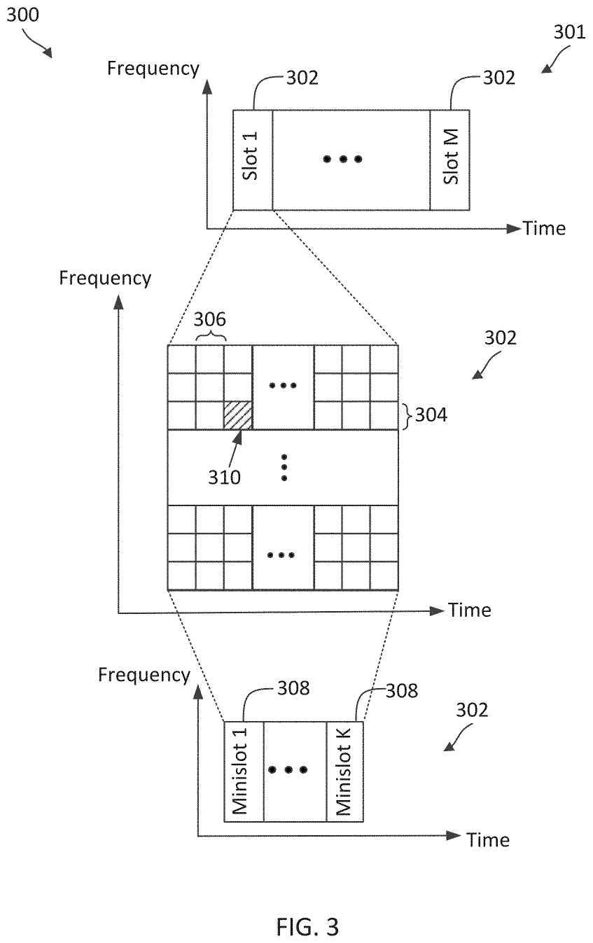

The configured grant resource 234 may be referred to as a time-frequency resource, which is explained in greater detail in FIG. 3. FIG. 3 is a timing diagram illustrating a transmission frame structure 300 according to some embodiments of the present disclosure. The transmission frame structure 300 may be employed by BSs such as the BSs 105 and UEs such as the UEs 115 in a network such as the network 100 for communications. In particular, the BS may communicate with the UE using time-frequency resources configured as shown in the transmission frame structure 300. In FIG. 3, the x-axes represent time in some arbitrary units and the y-axes represent frequency in some arbitrary units. The transmission frame structure 300 includes a radio frame 301. The duration of the radio frame 301 may vary depending on the embodiments. In an example, the radio frame 301 may have a duration of about ten milliseconds. The radio frame 301 includes M number of slots 302, where M may be any suitable positive integer. In an example, M may be about 10.

Each slot 302 includes a number of subcarriers 304 in frequency and a number of symbols 306 in time. The number of subcarriers 304 and/or the number of symbols 306 in a slot 302 may vary depending on the embodiments, for example, based on the channel bandwidth, the subcarrier spacing (SCS), and/or the cyclic prefix (CP) mode. One subcarrier 304 in frequency and one symbol 306 in time forms one resource element (RE) 310 for transmission. Multiple REs 310 may be correspond to the configured grant resource 234 in FIG. 2.

A BS (e.g., BS 105 in FIG. 1) may schedule a UE (e.g., UE 115 in FIG. 1) for UL and/or DL communications at a time-granularity of slots 302 or mini-slots 308. Each slot 302 may be time-partitioned into K number of mini-slots 308. Each mini-slot 308 may include one or more symbols 306. The mini-slots 308 in a slot 302 may have variable lengths. For example, when a slot 302 includes N number of symbols 306, a mini-slot 308 may have a length between one symbol 306 and (N-1) symbols 306. In some embodiments, a mini-slot 308 may have a length of about two symbols 306, about four symbols 306, or about seven symbols 306. The BS may configure certain time-frequency resources (e.g., a set of REs 310) within a slot 302 for DL control channel monitoring and the resources may be repeated at some intervals (e.g., every 40 ms). The BS may indicate UL and/or DL scheduling grants in the DL control channel.

Referring back to FIG. 2, in PUSCH, the CG-UCI and/or normal UCI may be multiplexed along with the configured-UL data. In another example, only the CG-UCI may be multiplexed with the configured-UL data, without the normal UCI. When a dropped UL transmission or dropped DL transmission is associated with a feedback and retransmission process such as a HARQ process, the dropped transmission can cause errors and/or inefficiency in the feedback and retransmission process. In a HARQ process, a transmitting node may transmit various coded versions of information data to a receiving node. For example, the transmitting node may transmit a first coded version of information data to the receiving node. Upon receiving a NACK signal from the receiving node, the transmitting node may transmit a second coded version of the information data to the receiving node. The receiving node may perform soft-combining to combine the received first coded version and the received second coded version for error correction when both the received first coded version and the received second coded version are erroneous. Thus, a dropped scheduled transmission that the receiving node is not aware of can corrupt the soft buffer (e.g., used for the soft-combining) at the receiving node. In some embodiments, a transport block may be divided into multiple code blocks (CBs). A code block group (CBG) may be formed from a group of the CBs within the transport block. Thus, a transport block can include one or more CBGs. Feedbacks for ACKs/NACKs can be indicated in units of CBGs and data can be retransmitted in units of CBGs.

For a scheduled UL transmission, the DCI 220 may include a DL assignment index (DAI) and specify the number of ACK/NACK bits that should be sent together in the same PUSCH. In the scheduled-UL scenario, the BS may transmit a first DCI indicating a DL grant with a DAI of 0 and a second DCI indicating a DL grant with a DAI of 1, the first and second DCI pointing to the same UL resource. The BS may also transmit a UL grant with a DAI of 1 pointing to the same resource. The DL grants and UL grant point to the same/overlapping resource in time. Accordingly, the UE may be expected to transmit a PUSCH with ACK/NACK bits corresponding to both the DL grants. If the UE does not receive any UL grants for that resource, the UE may transmit the ACK/NACK bits associated with the two PDSCHs in a PUCCH.

Each DL grant may have a corresponding ACK/NACK feedback, and the BS may indicate the number of ACK/NACK bits expected by the BS in the HARQ-ACK/NACK. An enhanced dynamic HARQ-ACK feedback allows for HARQ-ACK feedback of multiple groups of ACK/NACK. With a dynamic ACK, a DAI may be included in each DCI (e.g., DL/UL grant), which indicates the number of ACKS that are transmitted together in the same PUCCH/PUSCH.

The UE may count the number of DL grants received, determine on which resource to transmit the ACK/NACK, and the number of ACK/NACK bits to transmit in the resource. If the UE receives and decodes the first DCI (DAI=0), but misses the second DCI (DAI=1), the UE is able to determine that it missed the DL grant indicated in the second DCI because the number of DAIs would be mismatched with the requested number of DAIs indicated in the UL grant. In this example, the HARQ UCI payload is two bits, and may indicate the following: {HARQ ID0=ACK, HARQ ID1=NACK}.

For a configured UL transmission, the UE sends the UL transmission without an explicit grant from the BS. If the UE misses a DL grant, the UE may not have an accurate count of the number of ACK/NACK bits to transmit. An ambiguity in DAI payload size may arise due to an uncertainty in the number of ACK/NACK bits that are sent along with the configured-UL data. An incorrect assumption regarding the number of ACK/NACK bits may lead to errors in decoding remaining UCIs and in decoding the PUSCH. If the configured-UL data is punctured by the ACK/NACK payload, a few bits may be in error in the configured-UL data. In another example, if the configured-UL data is rate matched around the UCI, an incorrect DAI payload size assumption of UCI may lead to a complete loss of configured-UL data. For example, using the above example in which the UE decodes the first DCI (DAI=0), but misses the second DCI (DAI=1), the UE would not figure out that it missed the DL grant indicated in the second DCI because no UL grant was indicated. In this example, the UE incorrectly assumes that the HARQ UCI payload is one bit, rather than two bits, and may indicate the following: {HARQ ID0=ACK}, while the BS expects two bits in the UCI payload. It may be desirable to transmit the CG-UCI in a manner that is robust to any errors in the number of ACK/NACK bits.

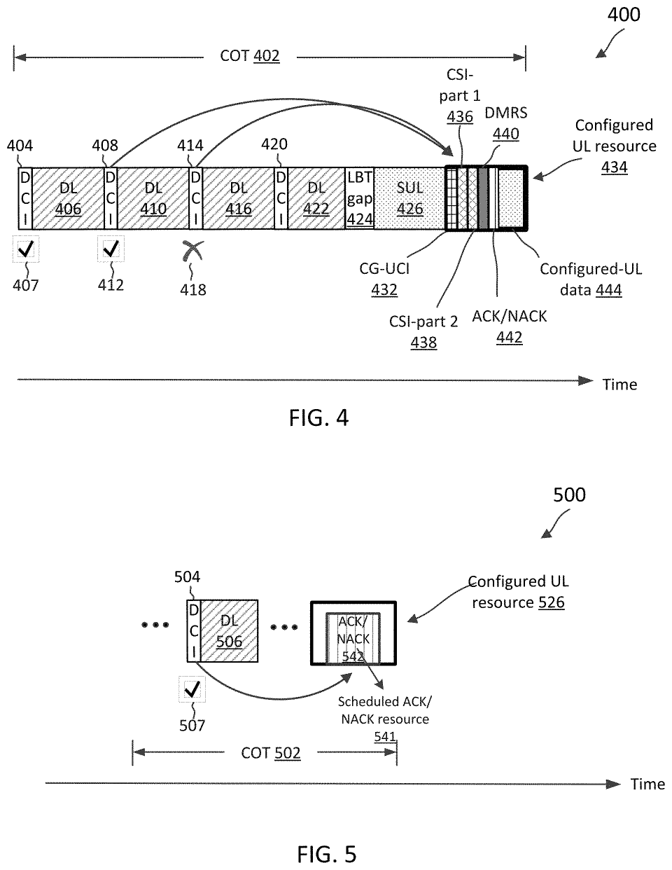

FIG. 4 illustrates a communication scheme 400 for multiplexing CG-UCI, at least one normal UCI, and/or UL data according to some embodiments of the present disclosure. The communication scheme 400 may be employed by UEs such as the UEs 115 and/or BSs such as BSs 105 in a network such as the network 100. In FIG. 4, the x-axis represents time in some constant units.

In FIG. 4, during a COT 402, the BS transmits DCI 404 indicating a UL grant and a DL grant for the UE and transmits DL data 406. The UE monitors for DCI. As indicated by a checkmark 407 associated with the DCI 404, the UE receives and decodes the DCI 407, in this example. The UE receives the DL data 406 based on the DL grant indicated in the DCI 404 and is scheduled for a UL transmission indicated by a scheduled uplink (SUL) 426. Additionally, during the COT 402, the BS transmits DCI 408 indicating a DL grant for the UE and transmits DL data 410. The DCI 408 may include a DAI field having an index value=0. As indicated by a checkmark 412 associated with the DCI 408, the UE receives and decodes the DCI 408. The UE receives the DL data 410 based on the DL grant indicated in the DCI 408. Additionally, during the COT 402, the BS transmits DCI 414 indicating a DL grant for the UE and transmits DL data 416. The DCI 414 may include a DAI field having an index value=1. As indicated by an “X” 418 associated with the DCI 414, the UE misses the DCI 414, in this example. Accordingly, the UE misses the DL grant indicated in the DCI 414 and the DL data 416. Additionally, during the COT 402, the BS transmits DCI 420 indicating a DL grant for the UE and transmits DL data 422. After completing the DL transmission (e.g., DL data 422), the BS may monitor for a UL transmission. An LBT gap 424 may be between an end of transmission of the DL data 422 and a start of the SUL 426. For example, the UE may perform an LBT during the LBT gap 424 due to the link switching from DL to UL. The UE may transmit UCI and/or UL data via the SUL 426 based on a successful LBT.

The UE may transmit a UL communication signal via a configured UL resource 434. In an example, the UE may receive a configuration for a configured grant resource from the BS. In an example, the UE receives a RRC configuration message with semi-persistent resources for one or more configured-grant UL resources. The UE transmits a UL communication signal in the configured UL resource 434, which may include a CG-UCI 432 multiplexed with normal UCI and/or the UL data (e.g., configured-UL data 444). The normal UCI may include CSI-part 1 436, CSI-part 2 438, ACK/NACK 442, and/or a SR. The ACK/NACK 442 may be feedback for the DL data 410 and the DL data 416. In some aspects, the UE transmits a UL communication signal including UCI, where the UCI includes at most four UCI parts including CG-UCI 432, CSI-part 1 436, CSI-part 2 438, and ACK/NACK 442, which may each be independently encoded and multiplexed together. In some aspects, a total number of independently encoded UCI parts included in a UL communication signal may not exceed a threshold (e.g., a maximum of three UCI parts). To comply with the aforementioned restriction, the UE may discard the CG-PUSCH along with its CG-UCI or the UE may discard any of the three UCI parts (e.g., CSI-part 1, CSI-part 2, or HARQ ACK/NACK) in the normal UCI. The UE may determine, based on one or more predefined rules or priorities, whether to discard the CG-PUSCH along with its CG-UCI or to discard any of the three UCI parts. The aforementioned predefined rules or priorities may be defined in the specification or RRC configured. The UE may determine that a first number of UCI parts for transmission in the UL communication signal exceeds a threshold. In some aspects, in response to a determination that the first number of UCI parts exceeds the threshold, the UE may select at least one of the CSI-part 1, the CSI-part 2, or the HARQ ACK/NACK. The transmitted UL communication signal may be devoid of the one or more selected UCI parts, and a second number of UCI parts included in the UL communication signal may not exceed the threshold. In some aspects, in response to a determination that the first number of UCI parts exceeds the threshold, the UE may determine to discard the CG-UCI from transmission in the UL communication signal, where the transmitted UL communication signal is devoid of the CG-UCI. The UE may also determine to discard the CG-PUSCH from transmission in the UL communication signal, where the UL communication signal may be devoid of the CG-UCI and the CG-PUSCH. In some aspects, the CG-UCI may include an indication of which UCI parts are included in the UCI and/or which UCI parts are discarded. In some aspects, in response to a determination that the first number of UCI parts exceeds the threshold, the UE determines to discard a set of UCI parts from transmission in the UL communication signal, where the transmitted UL communication signal is devoid of the set of UCI parts.

Additionally, the UL communication signal may include a DMRS 440, which may facilitate channel estimation and decoding at the BS. The UCI may be transmitted in separate resources (e.g., different OFDM symbols) from the DMRS 440. The different types of UCI transmitted as part of the normal UCI may be separated by the DMRS 440. For example, in FIG. 4, the DMRS 440 is positioned between the CSI (e.g., the CSI-part 1 436 and the CSI-part 2 438) and the ACK/NACK 442.

The UE may transmit the CG-UCI 432 such that it is decoded by the BS before the normal UCI and/or the UL data. The CG-UCI 432 is related to the transmissions within the configured grant resource and can enable robust decoding of the other normal UCIs. The CG-UCI 432 indicates information associated with the normal UCI (e.g., CSI-part 1 436, CSI-part 2 438, ACK/NACK 442) and/or the configured-UL data 444. In some examples, the CG-UCI 432 indicates the number of normal UCIs included in the configured UL resource 434, which normal UCIs are included in the configured UL resource 434, the payload size of those UCIs, and/or the number of ACK/NACK bits for HARQ ACK/NACK included in the configured UL resource 434. All DL grants pointing to the same UL resource may form a group. In an example, in a DL grant, the DCI may indicate a current ACK/NACK group index as well as an indication from the BS to the UE to include ACK/NACK feedback for other ACK/NACK groups. The ACK/NACK feedback for other ACK/NACK groups may be a second request by the BS to send the feedback. For example, the BS may provide an indication to the UE to include the ACK/NACK feedback for the other ACK/NACK groups if the aforementioned feedback was previously requested on a different resource, but the BS was unable to decode it. In such cases, the CG-UCI 432 may indicate multiple DAIs for multiple groups of ACK/NACK. For example, CG-UCI 432 may indicate at least one DAI associated with the HARQ ACK/NACK. In another example, CG-UCI 432 may indicate at least two DAI associated with the HARQ ACK/NACK, one DAI corresponding to the current group and the other(s) corresponding to the additional group(s). Accordingly, the UE and the BS may be in synchronization regarding the expected number of ACK/NACK bits associated with a feedback.

In some examples, the CG-UCI 432 indicates the HARQ-identifier (HARQ-ID) being used for PUSCH (e.g., the configured-UL data 444), the new data indicator (NDI) being used for PUSCH, the redundancy version (RV), the LBT class priority, and/or the MCOT duration, etc. Accordingly, the UE may transmit a HARQ-ID on any configured grant resource, providing a robust mechanism for handling LBT-related failures. The CG-UCI 432 may indicate other information about the normal UCI and/or the UL data being sent in PUSCH.

The communication scheme 400 may provide for enhanced dynamic HARQ-ACK feedback, which allows HARQ-ACK feedback of multiple groups of ACK/NACK in the same resource. With a dynamic ACK, a DAI may be included in each DCI, which indicates the number of ACKS that are transmitted together in the same feedback resource. If feedback from additional groups is needed, the DCI may include additional DAI(s) corresponding to ACK/NACK feedback for the other groups.

In FIG. 4, the UE may transmit the CG-UCI 432 in such a manner that is it decodable before at least one or all of the normal UCI and/or the configured-UL data 444. In other words, its location/multiplexing is independent of the location of the other UCIs. As an example, the UE may transmit the CG-UCI 432 in the earliest time slot of the configured grant resource (e.g., configured UL resource 434). In an example, the UE may transmit the CG-UCI 432 starting at the first symbol in REs not containing DMRS. In general, the CG-UCI 432 can be located at any predetermined location within the configured UL resource 434. For example, it should be understood that it is unnecessary for the CG-UCI 432 to be positioned physically before the normal UCI. Additionally, the location of the CG-UCI 432 may be determined independent from the normal UCI. As discussed, the CG-UCI 432 may carry additional information about normal UCI and/or configured-UL data whose multiplexing locations are determined after that of the CG-UCI 432. Additionally, the UE may transmit the ACK/NACK bits (e.g. ACK/NACK 442) after the first DMRS symbol of the UL-shared channel (UL-SCH). Additionally, the UE may transmit the CSI-part 1 436 and the CSI-part 2 438 starting at the next symbol after the CG-UCI 432. If the UE is unable to transmit the CSI-part 1 436 and/or the CSI-part 2 438 before transmission of the DMRS 440, which is a predetermined sequence, the UE may continue to transmit the CSI-part 1 436 and/or the CSI-part 2 438 after transmission of the DMRS 440 and the ACK/NACK REs. The UE may transmit the CSI-part 1 436 before transmitting the CSI-part 2 438. The UL data 444 (e.g., the UL data transmitted via the SUL 426 or the configured-UL data 444) may be rate matched around the UCI. In some examples, the UCI punctures the PUSCH. In another example (not shown), the CG-UCI REs may be multiplexed starting from the first symbol after the DMRS symbol, the ACK/NACK may start after the DMRS symbol as well and avoid any REs used for CG-UCI/DMRS, the CSI-part 1 may start from a pre-determined symbol of PUSCH possibly before the DMRS symbol (e.g. the first PUSCH symbol, second PUSCH symbol, etc.) and avoid all REs for DMRS/CG-UCI/ACK-NACK feedback, and/or the CSI-part 2 may be multiplexed avoiding any REs used for DMRS/CG-UCI/ACK-NACK feedback/CSI-part-1.

Other communication schemes are within the scope of the present disclosure. In some examples, rather than multiplexing four UCI (e.g., CG-UCI, CSI-part 1, CSI-part 2, HARQ-ACK feedback corresponding to DL data), a communication scheme may multiplex at most three UCI. By reducing the number of multiplexed UCI to three, the UE complexity may be reduced.

The BS may transmit a transmission configuration for a configured grant resource to the UE. In an example, the transmission configuration is a RRC configuration message. The UE receives the transmission configuration for the configured grant resource and transmits a UL communication signal in the configured grant resource. The UL communication signal may include at least one of a scheduled HARQ ACK/NACK or a configured grant transmission. In an example, the configured grant transmission is configured-UL data. In another example, the configured grant transmission is the CG-UCI. The BS receives the UL communication signal.

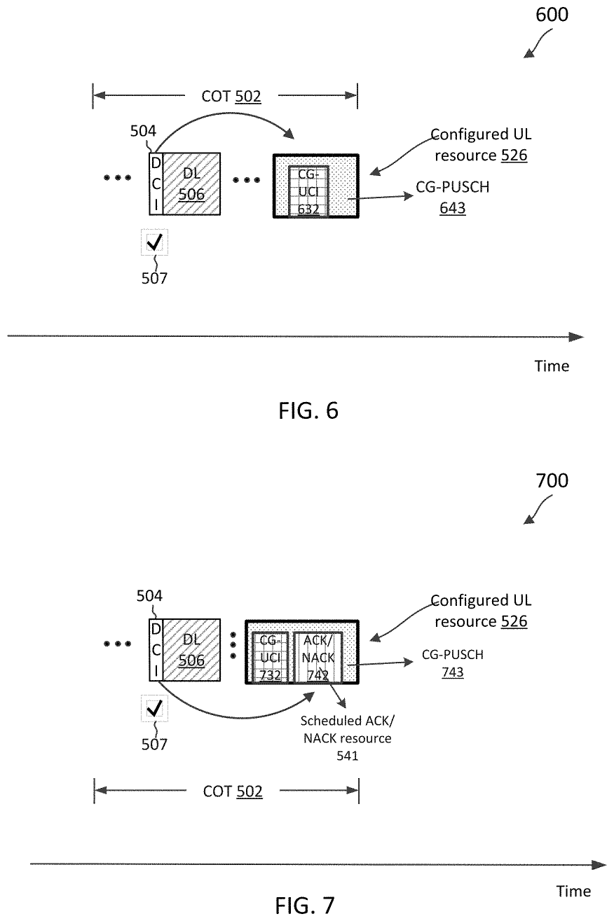

In some examples, a scheduled resource (e.g. ACK-NACK feedback) may collide with a configured grant resource. In a first transmission configuration, the UE may transmit either the scheduled ACK/NACK feedback on the scheduled resource or the configured grant transmission on the configured grant resource, but not both. In an example, if an ACK/NACK feedback is scheduled on a configured grant resource, the UE may skip the configured grant transmission on that resource. In this example, the UE may transmit the scheduled UCI (e.g., ACK/NACK feedback) on the scheduled resource and determine to not transmit the CG-UCI/CG-PUSCH (see FIG. 5). In another example, the UE may transmit the CG-UCI/CG-PUSCH on the configured grant resource if the UE determines that it does not have ACK/NACK bits to transmit on the scheduled resource (see FIG. 6).

FIG. 5 illustrates a communication scheme 500 for transmitting scheduled UCI (e.g., the scheduled ACK/NACK) in a configured UL resource according to some embodiments of the present disclosure. The communication scheme 500 may be employed by UEs such as the UEs 115 and/or BSs such as BSs 105 in a network such as the network 100. In FIG. 5, the x-axis represents time in some constant units. In FIG. 5, during a COT 502, the BS transmits DCI 504 indicating a UL grant and a DL grant for the UE and transmits DL data 506. The UE monitors for DCI. As indicated by a checkmark 507 associated with the DCI 504, the UE receives and decodes the DCI 507, in this example. Additionally, the UE receives the DL data 506 based on the DL grant indicated in the DCI 504. The DL grant may schedule the UE for an ACK/NACK transmission. The scheduled ACK/NACK resource 541 may be within or collide with the configured UL resource 526. The UE may perform a LBT before transmission in the configured UL resource 526, as discussed in FIG. 4.

The UE may determine whether it has HARQ ACK/NACK to transmit. In FIG. 5, the UE has HARQ ACK/NACK to transmit. If the UE has ACK/NACK bits 542 to transmit, the UE may transmit the ACK/NACK bits 542 on the configured UL resource 526, without transmitting CG-PUSCH on the configured UL resource 526, if the UE is configured with a multiplexing mode to now allow both CG-PUSCH and scheduled ACK/NACK bits. In this example, the UE may transmit a UL communication signal in the configured UL resource 526, and the UL communication signal may include the ACK/NACK bits 542. Additionally, the UL communication signal including the ACK/NACK bits 542 may be devoid of the configured grant transmission (e.g., CG-UCI/CG-PUSCH).

FIG. 6 illustrates a communication scheme 600 for multiplexing CG-UCI with CG-UL data according to some embodiments of the present disclosure. The communication scheme 600 may be employed by UEs such as the UEs 115 and/or BSs such as BSs 105 in a network such as the network 100. In FIG. 6, the x-axis represents time in some constant units. The COT 502, the DCI 504, the DL data 506, the checkmark 507, the scheduled ACK/NACK resource 541, and the configured UL resource 526 were discussed in relation to FIG. 5. Additionally, the scheduled ACK/NACK resource 541 is within the configured UL resource 526, in this example.

As discussed above in relation to FIG. 5, the DL grant indicated in the DCI 504 may schedule the UE for an ACK/NACK transmission. In FIG. 6, the communication scheme 600 illustrates a second transmission configuration in which the UE may transmit a configured grant transmission within the configured UL resource 526 if the UE determines that no HARQ ACK/NACK bits is scheduled that overlaps with the CG-UL resource 526. For example, the UE may transmit CG-UCI 632 and CG-PUSH 643 in the configured UL resource 526, without transmitting the ACK/NACK bits on the configured UL resource 526. In this example, the CG-UCI 632 is treated as HARQ-ACK payload bits and multiplexed using the HARQ-ACK multiplexing procedures. In FIG. 6, no DCI has scheduled an ACK/NACK to be transmitted within the CG-UL resource 526. The UE may transmit a UL communication signal in the configured UL resource 526, and the UL communication signal may include a configured grant transmission (e.g., CG-UCI 632 and/or CG-PUSH 643). The UL communication signal including the configured grant transmission may be devoid of the ACK/NACK bits. The configured grant transmission may be devoid of the ACK/NACK bits because, for example, there is no ACK/NACK scheduled or because the UE will transmit all NACK. Additionally, the HARQ-ACK bits are not sent at the same time as the configured grant transmission.

FIG. 7 illustrates a communication scheme 700 for multiplexing scheduled UCI (e.g., the scheduled ACK/NACK) with CG-UL data according to some embodiments of the present disclosure. The communication scheme 700 may be employed by UEs such as the UEs 115 and/or BSs such as BSs 105 in a network such as the network 100. In FIG. 7, the x-axis represents time in some constant units. The COT 502, the DCI 504, the DL data 506, the checkmark 507, the scheduled ACK/NACK resource 541, and the configured UL resource 526 were discussed in relation to FIG. 5. Additionally, the scheduled ACK/NACK resource 541 is within the configured UL resource 526, in this example.

As discussed above in relation to FIG. 5, the DL grant indicated in the DCI 504 may schedule the UE for an ACK/NACK transmission. In FIG. 7, the UE may determine that HARQ ACK/NACK bits should be sent using the scheduled ACK/NACK resource 541 and may multiplex the scheduled UCI (e.g., ACK/NACK bits 742) with the configured grant transmission including CG-PUSCH 743 and CG-UCI. The BS may transmit a multiplexing configuration specifying that the configured grant transmission and scheduled UCI can be multiplexed. The UE receives the multiplexing configuration. In response to a determination that the multiplexing configuration specifies that the configured grant transmission and scheduled UCI can be multiplexed, the UE may transmit the configured grant transmission and scheduled UCI together. In an example, the UE may transmit a UL communication signal in the configured UL resource 526, and the UL communication signal may include the ACK/NACK bits 742, the CG-PUSCH 743, and the CG-UCI 732. In this example, the ACK/NACK bits 742 are sent in the scheduled ACK/NACK resource 541 and multiplexed with the CG-PUSCH 743. In FIG. 7, the configured UL resource 526 includes CG-UCI 732, ACK/NACK bits 742, and CG-PUSCH 743. The CG-UL and the ACK/NACK may be transmitted within the configured UL resource 526 based on the multiplexing mode as will be discussed further below.

The second transmission configuration may be implemented in combination with the first transmission configuration such that the UE transmits either the HARQ-ACK feedback or the CG-UCI/CG-PUSCH in a UL communication signal. In an example, the UE transmits a UL communication signal including the configured grant transmission and is devoid of the scheduled HARQ ACK/NACK. In another example, the UE transmits a UL communication signal including the scheduled HARQ ACK/NACK and is devoid of the configured grant transmission. In an embodiment, the UE may prioritize the ACK/NACK transmission over the configured grant transmission. In another embodiment, the UE may determine whether to prioritize the ACK/NACK transmission over the configured grant transmission, and act accordingly. For example, rather than skipping the configured grant transmission as specified in the first transmission configuration, the UE may determine whether to transmit the ACK/NACK feedback or base it on actual feedback. In this example, the UE may prioritize the configured UL if all the ACK/NACK feedback is a NACK.

The UE may transmit the CG-UCI and the HARQ-ACK feedback using different beta offsets. A beta offset is a variable that controls the coding rate used for sending bits. The BS may have a different beta offset configured for each of the CG-UCI and the HARQ-ACK to control the coding rate of the HARQ-ACK and the CG-UCI independently even though the CG-UCI may be reusing the ACK-NACK multiplexed procedure. The beta offset is discussed in more detail below.

In a third transmission configuration, the UE may transmit CG-UCI and the HARQ-ACK feedback. For example, the UE may treat the CG-UCI as HARQ-ACK payload bits and multiplex the CG-UCI using the HARQ-ACK multiplexing procedures. In this example, the UE does not transmit the HARQ-ACK feedback and the CG-UCI at the same time. In some examples, the third transmission configuration is used in combination with the second transmission configuration.

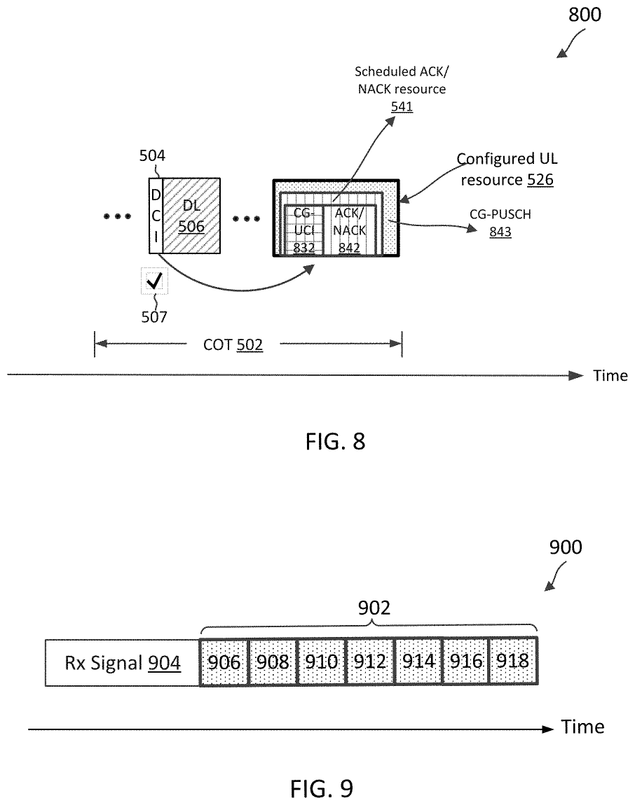

FIG. 8 illustrates a communication scheme 800 for multiplexing the CG-UCI and the HARQ-ACK according to some embodiments of the present disclosure. The communication scheme 800 may be employed by UEs such as the UEs 115 and/or BSs such as BSs 105 in a network such as the network 100. In FIG. 8, the x-axis represents time in some constant units. The COT 502, the DCI 504, the DL data 506, the checkmark 507, the scheduled ACK/NACK resource 541, and the configured UL resource 526 were discussed in relation to FIG. 5. Additionally, the scheduled ACK/NACK resource 541 is within the configured UL resource 526, in this example.

As discussed above in relation to FIG. 5, the DL grant indicated in the DCI 504 may schedule the UE for an ACK/NACK transmission. In FIG. 8, the UE has ACK/NACK bits 842 and CG-UCI 832 to transmit. If the UE has ACK/NACK bits 842 and CG-UCI 832 to transmit, the UE may transmit the ACK/NACK bits 842 and CG-UCI 832 as a single payload on the configured UL resource 526. In an example, the UE may multiplex the ACK/NACK bits 842 and the CG-UCI 832 in the scheduled ACK/NACK resource 541. The UE may additionally multiplex the CG-PUSCH 843 with the ACK/NACK bits 842 and CG-UCI 832 in the configured UL resource 526.

In some embodiments, the BS may switch between any of the communication schemes discussed in the present disclosure. In an example, the BS may switch between a first mode and a second mode in determining whether the CG-UCI is multiplexed or not along with the HARQ-ACK feedback bits before coding. The BS may determine which mode the UE should use and indicate the mode to the UE through the RRC configuration and/or configured grant activation DCI whether the CG-UCI is multiplexed or not along with the HARQ-ACK bits before coding.

In some embodiments, the BS may configure the UE with resources (e.g., time-frequency resources) and multiple starting points within a slot. A starting point may also be referred to as a starting offset and may be in units of symbols within a slot or any other suitable time. In an example, the starting points are not be aligned, and symbol boundaries may occur anywhere in between symbols. Due to the multiple starting points within a slot and the LBT constraint, the first few symbols may be punctured, potentially leading to the UCI (e.g., CSI-part-1 and/or CSI-part 2) being punctured (e.g., when transmission of the UCI begins from the first symbol in the slot). Additionally, the multiple starting points may impact UCI multiplexing.

In an example, the BS may configure a group of UEs to use the same slot associated with a configured grant resource, but configure each UE in the group of UEs to select different starting points at which the UE may start a UL transmission in the slot. The starting point may also be selected (e.g. randomly, based on a LBT result, etc.) by the UE from a configured set of starting points. The UE may perform a LBT and select a starting offset from a plurality of starting offsets for transmitting a UL communication signal in a configured grant resource based on the LBT. In an example, a first UE selects a first starting offset and a second UE selects a second starting offset that is later than the first starting offset. If the first UE performs LBT that results in a LBT pass, the first UE may start a UL transmission. When the second UE performs LBT, the second UE may detects signals from the first UE and perform LBT at a later point in time. The use of multiple starting offsets along with the UE' s LBT constraint allows the same configured grant resource to be used by multiple UEs that may or may not have a UL signal to transmit while minimizing collision across the UEs, thus providing for a more efficient system.

The UE may determine a configuration for transmitting the UL communication signal in the configured grant resource based on the starting offset. The UE may determine how many symbols in the configured grant resource are available for a UL transmission based on selecting the starting offset. The UE may transmit the UL communication signal based on the configuration to the BS. In an example, the UL communication signal may include UCI (e.g., CG-UCI and/or normal UCI), and the UE determines how to multiplex UCI (e.g., CSI-part 1, CSI-part 2, CG-UCI, HARQ-ACK feedback) based on the number of available symbols. The BS may receive the UL communication signal.

FIG. 9 is a timing diagram illustrating multiplexing of UCI with multiple starting offsets in a transmission scheme 900 according to some embodiments of the present disclosure. The scheme 900 may be employed by a BS such as the BSs 105 and a UE such as the UEs 115 in a network such as the network 100. In particular, a BS or a UE may employ scheme 900 to determine how to multiplex UCI. In FIG. 9, the BS may configure a group of UEs with resources and multiple starting offsets. In an example, the BS may configure a UE of the group of UEs with one or more configured grant resources and transmit this information to the UE via a communication signal 904 (shown as Rx signal).

In FIG. 9, the BS allocates a slot 902 with seven symbols 906, 908, 910, 912, 914, 916, and 918 for configured UL for transmission by a UE of the group of UEs. The slot 902 may correspond to a configured grant resource (e.g., a grant-free resource). The first symbol 906 may be a first OFDM symbol (e.g., OS#0), the second symbol 908 may be a second OFDM symbol (e.g., OS#1), the third symbol 910 may be a third OFDM symbol (e.g., OS#2), the fourth symbol 912 may be a fourth OFDM symbol (e.g., OS#3), the fifth symbol 914 may be a fifth OFDM symbol (e.g., OS#4), the sixth symbol 916 may be a sixth OFDM symbol (e.g., OS#5), and the seventh symbol 918 may be a seventh OFDM symbol (e.g., OS#6). Additionally, the BS may indicate a plurality of starting offsets (e.g., symbols, or points within the symbols) at which the UE may begin to perform UL transmissions within the slot 902. The plurality of starting offsets may be {first symbol 906, second symbol 908, and third symbol 910} or may be configured as specific time offsets (e.g. 9 us, 18 us, 27 us} after a start of the slot. The UE is not guaranteed transmission at any of the starting offsets due to the LBT constraint.

In an example, the UE selects a starting offset from a plurality of starting offsets. If LBT passes at the selected starting offset, the UE may start transmission at the starting offset. Different configurations are possible for multiplexing the UCI. In a first configuration, the UE starts multiplexing of UCI (e.g., CSI-part 1 and/or CSI-part 2) at the first symbol 906 (e.g., OS#0) independent of the selected starting offset. In an example, the UE may select the second symbol 908 (OS#2) as the selected starting offset for transmitting the UL communication signal in the slot 902. In this example, if LBT succeeds, the UE starts transmitting from the OS#2 and punctures the OS#1. The UCI thus gets punctured at the first symbol.

In a second configuration, the UE starts multiplexing of UCI from the first full symbol after the currently selected starting offset. In this configuration, as an example, if the UE selects the starting point at a middle of the first symbol, the UCI multiplexing starts at the beginning of the second symbol 908 (OS#1) (first full symbol after the selected starting point). In this example, the UE may transmit UCI (e.g., CSI-part 1 and/or CSI-part 2) starting at the second symbol 908. A BS may configure the UE with a starting offset at symbol 1 and symbol 2 of a slot. If the UE passes LBT within a duration of symbol 1, the UE may start transmission at the start of symbol 2. In an example, a partial symbol 1 may not be used for transmission if all transmissions are required to be aligned to a symbol boundary. Thus, the next full symbol after the LBT is symbol 2. In the second configuration, the CG-UCI may include information about the selected starting offset such that the BS knows which starting offset the UE is using to decode the UCI.

In a third configuration, the UE starts multiplexing of UCI from the first full symbol after the last starting offset. In this configuration, as an example, if the UE is configured with three starting points {OS#0, OS#1, OS#2} and the UE selects the OS#1 as the starting offset, the UE may multiplex UCI (e.g., CSI-part 1 and/or CSI-part 2) starting at the third symbol 910. Note that it would have started transmitting at the selected starting point (OS#2) as long as the LBT passes before the starting point 908. In the third configuration, it may be unnecessary for the BS to know which starting offset the UE is using to decode the UCI.

For the third configuration, the UE may start transmission of the UL communication signal based on the plurality of starting points allowed for a particular slot/mini-slot or based on a larger set of allowed starting points. In some examples, the plurality of starting points for a slot may vary depending on whether the slot falls within BS-acquired COT or outside the BS-acquired COT. The plurality of starting points for a slot can be a function of whether the slot falls within a BS-acquired COT or outside the BS-acquired COT. In an example, the BS may be unaware of whether the UE knows whether the slot 902 falls within the BS-acquired COT or outside the BS-acquired COT. In this example, it may be advantageous for the UE to start transmission of the UL communication signal based on the larger set of starting points (e.g., starting points for within a BS-acquired COT or outside of the BS-acquired COT). In some examples, the plurality of starting points may vary based on the allocation (e.g., as a function of allocation). For example, a full-band allocation may have multiple starting points but partial-band allocation (e.g., allocation including a subset of interlaces) may have a fixed starting point. It may be advantageous for the UE to start transmission of the UL communication signal based on the configured list of starting points if the BS is aware of the exact location of the plurality of starting points.

As the starting point may vary because of the multiple starting points that may be selected and used by the UE for transmission, the number of REs to use for UCI may also vary. The number of PUSCH symbols is a variable depending on which starting point the UE uses for transmission.

In some examples, the BS and/or the UE computes the number of REs to use for UCI as follows:

$${Q}^{′} = min \{ ⌈ \frac{O * {M}_{sc}^{PUSCH} * {N}_{symb}^{PUSCH} * {β}_{offset}^{PUSCH}}{{O}_{CSI}} ⌉ , {M}_{sc}^{PUSCH} * {N}_{symb}^{PUSCH} \} , , \qquad Eq ( 1 )$$

where (1) “Q′” represents the number of REs to use for UCI and is a minimum of the operands in the min operation, (2) “O” represents the number of ACK/NACK bits for transmission by the UE to the BS, (3) “M_{sc}^{PUSCH}” represents the number of subcarriers per symbol allocated to PUSCH, (4) “N_{symb}^{PUSCH}” represents the number of non-DMRS symbols that are allocated to PUSCH, (5) “β_{offset}^{PUSCH}” (e.g. beta offset) represents the coding rate used sending bits, and (6) “O_{CSI}” represents the number of CSI-related bits for transmission by the UE to the BS.

In Eq (1), the “Q′” may determine, for example, the number of frequency tones or REs that will be used for transmission of a particular UCI (e.g., CSI-part 1 or CSI-part 2). Additionally, the “O” may be based on a number of ACK/NACK bits indicated by a DL grant. Additionally, the “O_{CSI}” may be periodically configured via RRC signaling. Additionally, the BS may configure the beta offset via RRC signaling and may use the beta offset to control the coding rate for sending bits. For example, if channel conditions are bad (e.g., a low SNR), the BS may configure a large beta offset (e.g., 0.9) to achieve a lower coding rate. Conversely, if channel conditions are good (e.g., a high SNR), the BS may configure a small beta offset (e.g., 0.1) to achieve a higher coding rate.

The “N_{symb}^{PUSCH}” variable is updated based on the starting offset (e.g., skipping beginning symbols due to use of a non-zero starting point offset). The BS and/or UE may continue to compute the number of REs in accordance with Eq (1) based on the “N_{symb}^{PUSCH}” variable being updated. The BS and/or the UE may update Eq (1) in a variety of ways. In a first update configuration, the BS and/or UE updates the Eq (1) based on the allocated number of non-DMRS PUSCH symbols, without considering the starting point. Using the first update configuration, it may be unnecessary to take into consideration the UE starting at a later point. However, the number of REs that are calculated may be more than the number of REs available in the PUSCH. In this example, UCI and/or configured-UL data may be punctured because there is not enough REs to carry the prepared data.

In a second update configuration, the BS and/or UE updates the Eq (1) based on the actual number of full non-DMRS PUSCH symbols that are transmitted (e.g., after the actual starting point). Using the second update configuration, if the UE were to select a starting point between the first and second symbol, the BS and/or the UE may determine how many data symbols are remaining starting from the second symbol, and use the remaining number of data symbols for “N_{symb}^{PUSCH}” in the Eq (1). In this computation, consideration of the first symbol may be unnecessary.

In a third update configuration, the BS and/or UE updates the Eq (1) based on the minimum number of full non-DMRS PUSCH symbols that are guaranteed to be transmitted (e.g., after the last starting point). It may be advantageous for the UE to implement the third update configuration because the UE may compute the UCI REs without knowing the starting point.

Using the second and third update configurations, the BS and/or the UE may update the number of PUSCH symbols, thus adjusting the value of the variables in Eq (1).

In some examples, different UCIs may use different definitions of “N_{symb}^{PUSCH}” in the Eq (1). For example, if the CG-UCI indicates a starting point of the UCI transmission, the BS and/or the UE may be unable to use the second update configuration for calculating the number of REs to use for transmission of the CG-UCI. However, the BS and/or the UE may still be able to use the second update configuration for calculating the number of REs to use for transmission of the normal UCI since it obtains the starting point from the CG-UCI which is decoded first. In another example, if the UE transmits a first UCI and does not know the starting point of the transmission, the UE may assume that transmission of the first UCI started at the last starting point. For a second UCI subsequent to the first UCI in transmission, the BS may indicate the starting point in the first UCI. For the second UCI and subsequent UCIs, the BS and/or the UE may use the actual starting point rather than the last starting point for updating the “N_{symb}^{PUSCH}” in the Eq (1). In the update configurations and examples above, the ending point selected by the UE may be implicitly assumed in choosing the actual or minimum number of non-DMRS or PUSCH symbols (between starting and ending points). In some examples, the computation for the number of REs (Eq (1)) for a UCI or part of the UCI (e.g. CG-UCI, ACK/NACK, CSI-part 1, and CSI-part 2) may explicitly depend on the selected starting and/or ending point by the UE.

In some examples, the BS and/or the UE may define one or more variables in Eq (1) differently for different UCI (e.g., the normal UCI or the CG-UCI). In Eq (1), the “N_{symb}^{PUSCH}” appears in the first and second operand of the min function. In an example, the limit on the maximum number of REs “M_{sc}^{PUSCH}·N_{symb}^{PUSCH}”(e.g., right-hand side of the Eq (1)) may use a different definition of “N_{symb}^{PUSCH}” than when computing the

$$“ ⌈ \frac{O * {M}_{sc}^{PUSCH} \cdot {N}_{symb}^{PUSCH} \cdot {β}_{offset}^{PUSCH}}{{O}_{CSI}} ⌉ ”$$

(e.g., left-hand side of the Eq (1)). For example, the BS and/or the UE may continue to update the “N_{symb}^{PUSCH}” variable on the right-hand side of Eq (1), and may define the “N_{symb}^{PUSCH}” variable on the left-hand side as the number of allocated non-DMRS PUSCH symbols.

As discussed above, BS may configure a plurality of starting points for a UE for transmission of UCI. The UE may select a starting point from the plurality of starting points for starting the UCI transmission (e.g., transmission of CSI-part 1 and/or CSI-part 2). In some embodiments, the BS may configure a plurality of LBT starting points for a UE to provide more robustness against LBT failure. Due to LBT failure, the PUSCH waveform may be created for the slot and then punctured. In an example, the BS may configure starting points at symbol 0 and symbol 7 within a slot. In this example, the UE may perform a first LBT for a transmission vicinity of symbol 0 (e.g., a first starting point offset from symbol 0) in the first half of the slot. If the first LBT results in a LBT pass, the UE may transmit PUSCH using the full slot. If, however, the first LBT results in a LBT fail, the UE may perform the second LBT in vicinity of symbol 7 (e.g., a second starting point offset from symbol 7) in the second half of the slot. If the second LBT results in a LBT pass, the UE may transmit PUSCH using the second half of the slot.

The BS may configure a plurality of starting points to allow for potential LBT delays at the UE, which may impact the UE in determining how to multiplex the UCI. The above discussion regarding use of the last starting point for determining “N_{symb}^{PUSCH}” and the OFDM symbols for UCI may apply here as well. In an example, the UE may consider a last starting point due to LBT failure. In another example, the last starting point considered for UCI multiplexing may be different for different LBT-related starting points. For example, the BS may configure a plurality of starting points {symbol 0, symbol 1, symbol 2, symbol 7, symbol 8, symbol 9}. If the UE performs LBT at the starting points of symbols 0, 1, and 2, PUSCH may be created for a full slot, but the symbols 1 and 2 may be punctured in relation to the starting points of symbols 1 and 2. If the UE performs LBT at the starting points of symbols 7, 8, and 9, PUSCH may be created for half of a slot, but the symbols 8 and 9 may be punctured in relation to the starting points of symbols 8 and 9. In this example, a different last starting point is used for the different LBT starting points (e.g., one starting point for {symbol 0, symbol 1, symbol 2} and a different laset starting point for {symbol 7, symbol 8, symbol 9} for the purposes of determining symbols where UCI is multiplexed and for determining the number of REs to use for UCI.

In some examples, the CG-UCI may indicate the starting symbol to use for the LBT and/or for the transmission of UCI. Such an implementation may be advantageous when the very first slot in back-to-back configured grant slots is punctured.

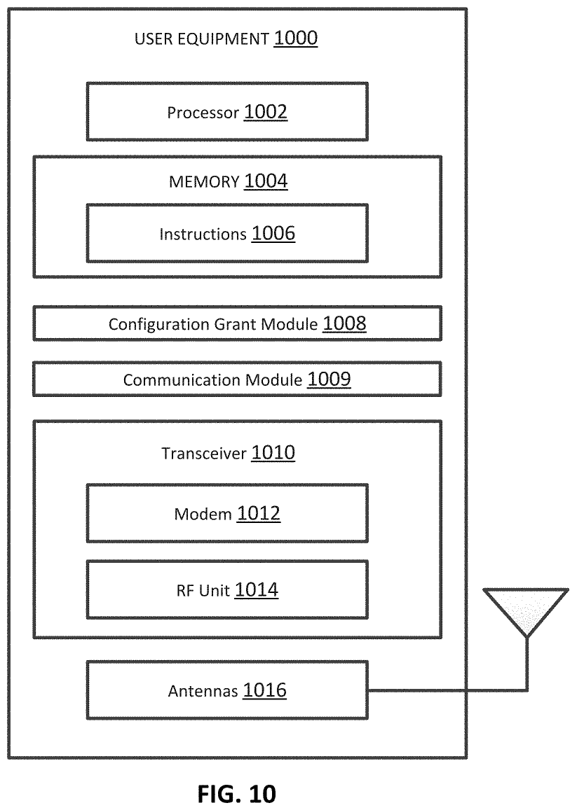

FIG. 10 is a block diagram of an exemplary UE 1000 according to some embodiments of the present disclosure. The UE 1000 may be a UE 115 as discussed above. As shown, the UE 1000 may include a processor 1002, a memory 1004, a configuration grant module 1008, a communication module 1009, a transceiver 1010 including a modem subsystem 1012 and an RF unit 1014, and one or more antennas 1016. These elements may be in direct or indirect communication with each other, for example, via one or more buses.

The processor 1002 may have various features as a specific-type processor. For example, these may include a central processing unit (CPU), a digital signal processor (DSP), an application specific integrated circuit (ASIC), a controller, a field programmable gate array (FPGA) device, another hardware device, a firmware device, or any combination thereof configured to perform the operations described herein. The processor 1002 may also be implemented as a combination of computing devices, e.g., a combination of a DSP and a microprocessor, a plurality of microprocessors, one or more microprocessors in conjunction with a DSP core, or any other such configuration.

The memory 1004 may include a cache memory (e.g., a cache memory of the processor 1002), random access memory (RAM), magnetoresistive RAM (MRAM), read-only memory (ROM), programmable read-only memory (PROM), erasable programmable read only memory (EPROM), electrically erasable programmable read only memory (EEPROM), flash memory, a solid state memory device, one or more hard disk drives, memristor-based arrays, other forms of volatile and non-volatile memory, or a combination of different types of memory. In some embodiments, the memory 1004 includes a non-transitory computer-readable medium. The memory 1004 may store instructions 1006. The instructions 1006 may include instructions that, when executed by the processor 1002, cause the processor 1002 to perform the operations described herein with reference to the UEs 115 in connection with embodiments of the present disclosure. Instructions 1006 may also be referred to as code. The terms “instructions” and “code” should be interpreted broadly to include any type of computer-readable statement(s). For example, the terms “instructions” and “code” may refer to one or more programs, routines, sub-routines, functions, procedures, etc. “Instructions” and “code” may include a single computer-readable statement or many computer-readable statements.

The configuration grant module 1008 and/or the communication module 1009 may be implemented via hardware, software, or combinations thereof. For example, the configuration grant module 1008 and/or communication module 1009 may be implemented as a processor, circuit, and/or instructions 1006 stored in the memory 1004 and executed by the processor 1002. The configuration grant module 1008 and/or the communication module 1009 may be used for various aspects of the present disclosure.

In some examples, the configuration grant module 1008 may be configured to receive a configuration for a configured grant resource. In an example, the configuration grant module 1008 receives the configuration via a RRC message from a BS (e.g., BS 105). The communication module 1009 may be configured to transmit a UL communication signal in the configured grant resource. The UL communication signal may include a CG-UCI multiplexed with UL data, and the CG-UCI may indicate whether the UL communication signal also includes first UCI (e.g., normal UCI). The first UCI may include, for example, a HARQ ACK/NACK, a CSI-part 1, and/or a CSI-part 2.

In some examples, the configuration grant module 1008 may be configured to receive a transmission configuration for a configured grant resource. Additionally, the communication module 1009 may be configured to transmit a UL communication signal in the configured grant resource. The UL communication signal may include at least one of a scheduled HARQ ACK/NACK or a configured grant transmission.

In some examples, the configuration grant module 1008 may be configured to receive multiplexing configuration information associated with a configured grant resource and HARQ-ACK feedback, the multiplexing configuration information specifying a no-multiplex mode or a multiplex mode. In response to a determination that the multiplexing configuration information specifies the no-multiplex mode for a slot, the configuration grant module 1008 may be configured to determine whether to transmit the HARQ-ACK feedback or the CG-UL data in the slot, transmit the HARQ-ACK feedback in the slot in response to a determination to transmit the HARQ-ACK feedback; and transmit the CG-UL data in the slot in response to a determination to transmit the CG-UL data. In response to a determination that the multiplexing configuration information specifies the multiplex mode for the slot, the configuration grant module 1008 may be configured to transmit a UL communication signal in the configured grant resource, the UL communication signal including the CG-UL data multiplexed with the HARQ-ACK feedback.

In some examples, the configuration grant module 1008 may be configured to receive a configuration providing a plurality of starting offsets to use for configured grant transmissions. The configuration grant module 1008 may be configured to select a starting offset from the plurality of starting offsets for transmitting a UL communication signal in a configured grant resource and further configured to determine a set of REs for multiplexing UCI in the configured grant resource based on the plurality of starting offsets or the selected starting offset. Additionally, the communication module 1009 may be configured to transmit the UL communication signal based on the configuration if LBT passes at the selected starting offset.

As shown, the transceiver 1010 may include the modem subsystem 1012 and the RF unit 1014. The transceiver 1010 can be configured to communicate bi-directionally with other devices, such as the BSs 105. The modem subsystem 1012 may be configured to modulate and/or encode the data from the memory 1004, the configuration grant module 1008, and/or the communication module 1009 according to a Modulation Coding Scheme (MCS), e.g., a low-density parity check (LDPC) coding scheme, a turbo coding scheme, a convolutional coding scheme, a digital beamforming scheme, etc. The RF unit 1014 may be configured to process (e.g., perform analog to digital conversion or digital to analog conversion, etc.) modulated/encoded data from the modem subsystem 1012 (on outbound transmissions) or of transmissions originating from another source such as a UE 115 or BS 105. The RF unit 1014 may be further configured to perform analog beamforming in conjunction with the digital beamforming. Although shown as integrated together in transceiver 1010, the modem subsystem 1012 and the RF unit 1014 may be separate devices that are coupled together at the UE 115 or 1000 to enable the UE 115 or 1000 to communicate with other devices.

The RF unit 1014 may provide the modulated and/or processed data, e.g. data packets (or, more generally, data messages that may contain one or more data packets and other information), to the antennas 1016 for transmission to one or more other devices. The antennas 1016 may further receive data messages transmitted from other devices. The antennas 1016 may provide the received data messages for processing and/or demodulation at the transceiver 1010. The antennas 1016 may include multiple antennas of similar or different designs in order to sustain multiple transmission links. The RF unit 1014 may configure the antennas 1016.

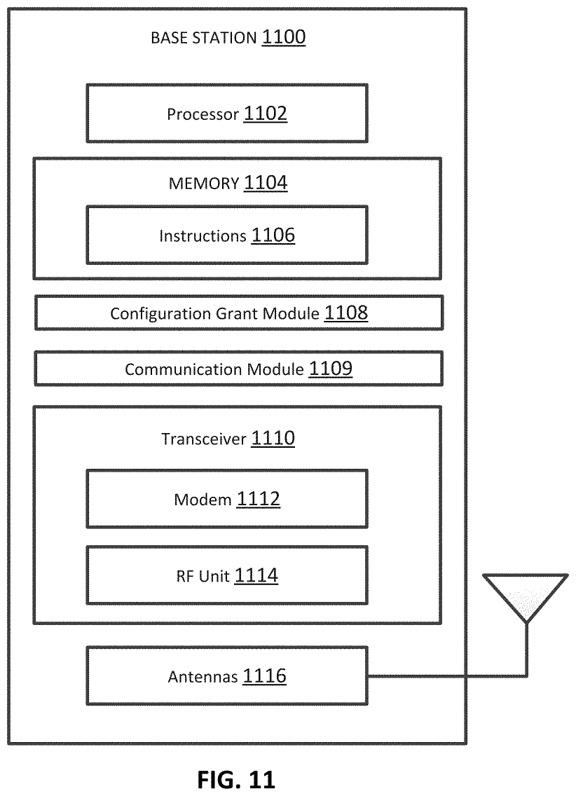

FIG. 11 is a block diagram of an exemplary BS 1100 according to some embodiments of the present disclosure. The BS 1100 may be a BS 105 as discussed above. As shown, the BS 1100 may include a processor 1102, a memory 1104, a configured grant module 1108, a communication module 1109, a transceiver 1110 including a modem subsystem 1112 and a radio frequency (RF) unit 1114, and one or more antennas 1116. These elements may be in direct or indirect communication with each other, for example via one or more buses.

The processor 1102 may include a CPU, a DSP, an ASIC, a controller, a FPGA device, another hardware device, a firmware device, or any combination thereof configured to perform the operations described herein. The processor 1102 may also be implemented as a combination of computing devices, e.g., a combination of a DSP and a microprocessor, a plurality of microprocessors, one or more microprocessors in conjunction with a DSP core, or any other such configuration.

The memory 1104 may include a cache memory (e.g., a cache memory of the processor 1102), RAM, MRAM, ROM, PROM, EPROM, EEPROM, flash memory, solid state memory device, hard disk drives, memristor-based arrays, other forms of volatile and non-volatile memory, or a combination of different types of memory. In some embodiments, the memory 1104 includes a non-transitory computer-readable medium. The memory 1104 may store instructions 1106. The instructions 1106 may include instructions that, when executed by the processor 1102, cause the processor 1102 to perform operations described herein with reference to the BSs 105 in connection with embodiments of the present disclosure. Instructions 1106 may also be referred to as code, which may be interpreted broadly to include any type of computer-readable statement(s) as discussed above with respect to FIG. 10.

The configured grant module 1108 and/or the communication module 1109 may be implemented via hardware, software, or combinations thereof. For example, the configured grant module 1108 and/or communication module 1109 may be implemented as a processor, circuit, and/or instructions 1106 stored in the memory 1104 and executed by the processor 1102. The configured grant module 1108 and/or the communication module 1109 may be used for various aspects of the present disclosure.

In some examples, the configuration grant module 1108 may be configured to transmit a configuration for a configured grant resource. In an example, the configuration grant module 1108 transmits the configuration via a RRC message to a UE (e.g., UE 115). The communication module 1109 may be configured to receive a UL communication signal in the configured grant resource. The UL communication signal may include a CG-UCI multiplexed with UL data, and the CG-UCI indicating whether the UL data includes first UCI.

In some examples, the configuration grant module 1108 may be configured to transmit a transmission configuration for a configured grant resource. The communication module 1109 may be configured to receive a UL communication signal in the configured grant resource, the UL communication signal including at least one of a scheduled HARQ ACK/NACK or a configured grant transmission.

In some examples, the configuration grant module 1108 may be configured to transmit multiplexing configuration information associated with a configured grant resource and HARQ-ACK feedback, the multiplexing configuration information specifying a no-multiplex mode or a multiplex mode. The communication module 1109 may be configured to receive a UL communication signal including in the HARQ-ACK feedback or the CG-UL data in response to transmitting the multiplexing configuration information specifying the no-multiplex mode. The communication module 1109 may be configured to receive a UL communication signal including the CG-UL data multiplexed with the HARQ-ACK feedback in response to transmitting the multiplexing configuration information specifying the multiplex mode.

In some examples, the configuration grant module 1108 may be configured to configure a plurality of starting offsets for transmission of a UL communication signal in a configured grant resource. The configuration grant module 1108 may be configured to determine a configuration for receiving the UL communication signal in the configured grant resource based on a starting offset of the plurality of starting offsets. The starting offset is based on a result of a LBT procedure performed by a UE. The configuration grant module 1108 receives the UL communication signal based on the configuration.

As shown, the transceiver 1110 may include the modem subsystem 1112 and the RF unit 1114. The transceiver 1110 can be configured to communicate bi-directionally with other devices, such as the UEs 115 and/or another core network element. The modem subsystem 1112 may be configured to modulate and/or encode data according to a MCS, e.g., a LDPC coding scheme, a turbo coding scheme, a convolutional coding scheme, a digital beamforming scheme, etc. The RF unit 1114 may be configured to process (e.g., perform analog to digital conversion or digital to analog conversion, etc.) modulated/encoded data from the modem subsystem 1112 (on outbound transmissions) or of transmissions originating from another source such as a UE 115 or BS 105. The RF unit 1114 may be further configured to perform analog beamforming in conjunction with the digital beamforming. Although shown as integrated together in transceiver 1110, the modem subsystem 1112 and the RF unit 1114 may be separate devices that are coupled together at the BS 105 or 1100 to enable the BS 105 or 1100 to communicate with other devices.

The RF unit 1114 may provide the modulated and/or processed data, e.g. data packets (or, more generally, data messages that may contain one or more data packets and other information), to the antennas 1116 for transmission to one or more other devices. The antennas 1116 may further receive data messages transmitted from other devices and provide the received data messages for processing and/or demodulation at the transceiver 1110. The antennas 1116 may include multiple antennas of similar or different designs in order to sustain multiple transmission links.

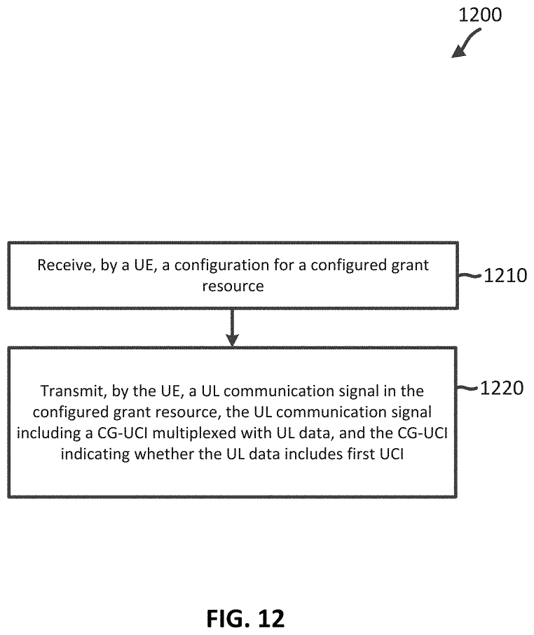

FIG. 12 is a flow diagram of a communication method 1200 according to embodiments of the present disclosure. Steps of the method 1200 can be executed by a computing device (e.g., a processor, processing circuit, and/or other suitable component) of a wireless communication device, such as the UEs 115 and 1000. In some examples, UE 115 and the UE 1000 may utilize one or more components, such as the processor 1002, the memory 1004, the configuration grant module 1008, the communication module 1009, the transceiver 1010, and/or the antennas 1016 to execute the steps of method 1200. The method 1200 may employ similar mechanisms as in the scheduling/configuration timeline 200 in FIG. 2, the timing diagram in FIG. 3, the communication scheme 400 in FIG. 4, the communication scheme 500 in FIG. 5, the communication scheme 600 in FIG. 6, the communication scheme 700 in FIG. 7, the communication scheme 800 in FIG. 8, and/or the transmission scheme 900 in FIG. 9. As illustrated, the method 1200 includes a number of enumerated steps, but embodiments of the method 1200 may include additional steps before, after, and in between the enumerated steps. In some embodiments, one or more of the enumerated steps may be omitted or performed in a different order.

At step 1210, the method 1200 includes receiving, by a UE, a configuration for a configured grant resource. At step 1220, the method 1200 includes transmitting, by the UE, a UL communication signal in the configured grant resource, the UL communication signal including a CG-UCI multiplexed with UL data, and the CG-UCI indicating whether the UL data includes first UCI. The UE may receive the configuration via receiving a RRC message indicating one or more configured group resources based on a SPS.

In an example, transmission of the UL communication signal may include multiplexing the CG-UCI in the configured grant resource. The UE may multiplex the CG-UCI and the UL data independent of whether the UL data includes the first UCI. Additionally, transmission of the UL communication signal may include multiplexing the first UCI in the configured grant resource. The transmission of the UL communication signal may include transmitting the CG-UCI in a set of REs, and multiplexing the first UCI may include avoiding the set of REs used by the CG-UCI for transmission of the first UCI.

The first UCI may include at least one of a HARQ ACK/NACK, CSI-part 1, or a CSI-part 2. The CG-UCI may provide various information. For example, the CG-UCI may provide information on a presence of one or more UCI including the first UCI, on an absence of the one or more UCI, and/or on a number of ACK/NACK bits for a HARQ ACK/NACK. In an example, the CG-UCI may indicate at least one DAI associated with the HARQ ACK/NACK. In another example, the CG-UCI may indicate at least two DAI associated with the HARQ ACK/NACK. In another example, the CG-UCI may indicate at least one of a HARQ-identifier associated with the UL data or a NDI associated with the UL data.

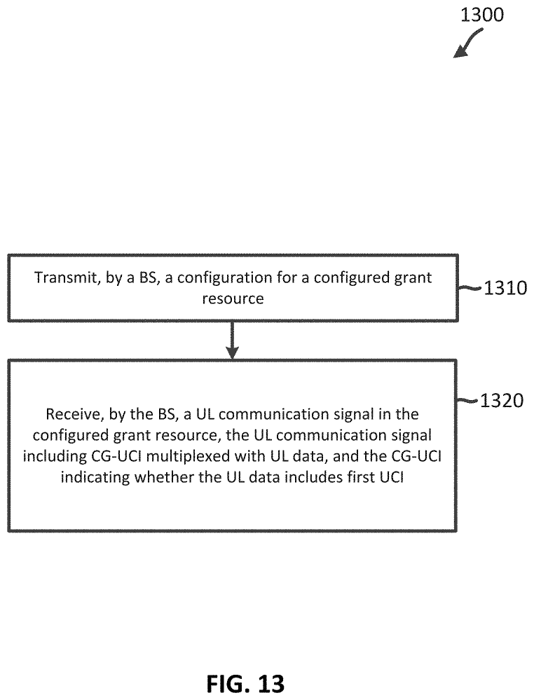

FIG. 13 is a flow diagram of a communication method 1300 according to embodiments of the present disclosure. Steps of the method 1300 can be executed by a computing device (e.g., a processor, processing circuit, and/or other suitable component) of a wireless communication device, such as the BSs 105 and 1100. In some examples, BS 105 and the BS 1100 may utilize one or more components, such as the processor 1102, the memory 1104, the configuration grant module 1108, the communication module 1109, the transceiver 1110, and/or the antennas 1116 to execute the steps of method 1300. The method 1300 may employ similar mechanisms as in the scheduling/configuration timeline 200 in FIG. 2, the timing diagram in FIG. 3, the communication scheme 400 in FIG. 4, the communication scheme 500 in FIG. 5, the communication scheme 600 in FIG. 6, the communication scheme 700 in FIG. 7, the communication scheme 800 in FIG. 8, and/or the transmission scheme 900 in FIG. 9. As illustrated, the method 1300 includes a number of enumerated steps, but embodiments of the method 1300 may include additional steps before, after, and in between the enumerated steps. In some embodiments, one or more of the enumerated steps may be omitted or performed in a different order.

At step 1310, the method 1300 includes transmitting, by a BS, a configuration for a configured grant resource. At step 1320, the method 1300 includes receiving, by the BS, a UL communication signal in the configured grant resource, the UL communication signal including a CG-UCI multiplexed with UL data, and the CG-UCI indicating whether the UL data includes first UCI.

The first UCI may include at least one of a HARQ ACK/NACK, CSI-part 1, or a CSI-part 2. Additionally, the CG-UCI may indicate a number of ACK/NACK bits for a HARQ ACK/NACK. In an example, the CG-UCI may indicate at least one DAI associated with the HARQ ACK/NACK. In another example, the CG-UCI may indicate at least two DAI associated with the HARQ ACK/NACK. In another example, the CG-UCI may indicate at least one of a HARQ-identifier associated with the UL data or a NDI associated with the UL data.

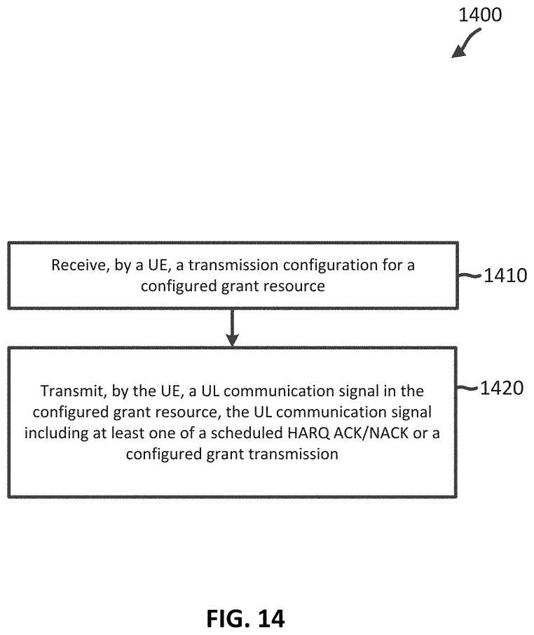

FIG. 14 is a flow diagram of a communication method 1400 according to embodiments of the present disclosure. Steps of the method 1400 can be executed by a computing device (e.g., a processor, processing circuit, and/or other suitable component) of a wireless communication device, such as the UEs 115 and 1000. In some examples, UE 115 and the UE 1000 may utilize one or more components, such as the processor 1002, the memory 1004, the configuration grant module 1008, the communication module 1009, the transceiver 1010, and/or the antennas 1016 to execute the steps of method 1400. The method 1400 may employ similar mechanisms as in the scheduling/configuration timeline 200 in FIG. 2, the timing diagram in FIG. 3, the communication scheme 400 in FIG. 4, the communication scheme 500 in FIG. 5, the communication scheme 600 in FIG. 6, the communication scheme 700 in FIG. 7, the communication scheme 800 in FIG. 8, and/or the transmission scheme 900 in FIG. 9. As illustrated, the method 1400 includes a number of enumerated steps, but embodiments of the method 1400 may include additional steps before, after, and in between the enumerated steps. In some embodiments, one or more of the enumerated steps may be omitted or performed in a different order.

At step 1410, the method 1400 includes receiving, by a UE, a transmission configuration for a configured grant resource. At step 1420, the method 1400 includes transmitting, by the UE, a UL communication signal in the configured grant resource, the UL communication signal including at least one of a scheduled HARQ ACK/NACK or a configured grant transmission. The UE may receive the transmission configuration via a RRC message indicating the configured grant resource.

In some examples, the configured grant transmission may include CG-UCI. In another example, the configured grant transmission may include configured-grant physical UL shared channel (CG-PUSCH). Additionally, the HARQ ACK/NACK may be associated with a first beta offset, the configured grant transmission may be associated with a second beta offset, and the first beta offset may be different from the second beta offset. Additionally, transmitting the UL communication signal may include transmitting the CG-UCI as part of a HARQ-ACK UCI payload.

In an example, the UE may transmit the UL communication signal by transmitting the configuration grant transmission if no HARQ ACK/NACK is to be transmitted in the UL communication signal. In this example, the UL communication signal may include the configured grant transmission and may be devoid of the scheduled HARQ ACK/NACK. In another example, the UL communication signal may include the scheduled HARQ ACK/NACK and may be devoid of the configured grant transmission.

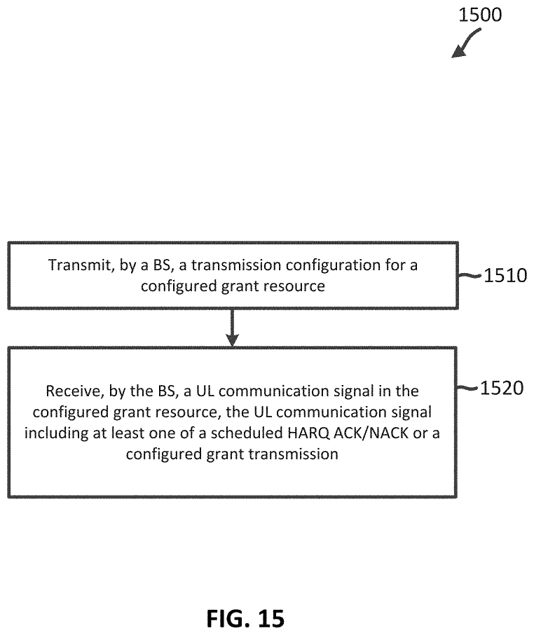

FIG. 15 is a flow diagram of a communication method 1500 according to embodiments of the present disclosure. Steps of the method 1500 can be executed by a computing device (e.g., a processor, processing circuit, and/or other suitable component) of a wireless communication device, such as the BSs 105 and 1100. In some examples, BS 105 and the BS 1100 may utilize one or more components, such as the processor 1102, the memory 1104, the configuration grant module 1108, the communication module 1109, the transceiver 1110, and/or the antennas 1116 to execute the steps of method 1500. The method 1500 may employ similar mechanisms as in the scheduling/configuration timeline 200 in FIG. 2, the timing diagram in FIG. 3, the communication scheme 400 in FIG. 4, the communication scheme 500 in FIG. 5, the communication scheme 600 in FIG. 6, the communication scheme 700 in FIG. 7, the communication scheme 800 in FIG. 8, and/or the transmission scheme 900 in FIG. 9. As illustrated, the method 1500 includes a number of enumerated steps, but embodiments of the method 1500 may include additional steps before, after, and in between the enumerated steps. In some embodiments, one or more of the enumerated steps may be omitted or performed in a different order.

At step 1510, the method 1500 includes transmitting, by a BS, a transmission configuration for a configured grant resource. At step 1520, the method 1500 includes receiving, by the BS, a UL communication signal in the configured grant resource, the UL communication signal including at least one of a scheduled HARQ ACK/NACK or a configured grant transmission.

In some examples, the BS may receive the UL communication signal by receiving the configuration grant transmission if no HARQ ACK/NACK is included in the UL communication signal. In an example, the configured grant transmission may include CG-UCI. In another example, the configured grant transmission may include configured-grant physical UL shared channel (CG-PUSCH). In an example, receiving the UL communication signal may include receiving the configuration grant transmission if no HARQ ACK/NACK is to be transmitted in the UL communication signal. In this example, the UL communication signal may include the configured grant transmission and may be devoid of the scheduled HARQ ACK/NACK. In another example, the UL communication signal may include the scheduled HARQ ACK/NACK and may be devoid of the configured grant transmission. In some examples, the BS configures a first beta offset for transmission of the CG-UCI and configures a second beta offset for transmission of the HARQ ACK/NACK, where the first beta offset is different from the second beta offset.

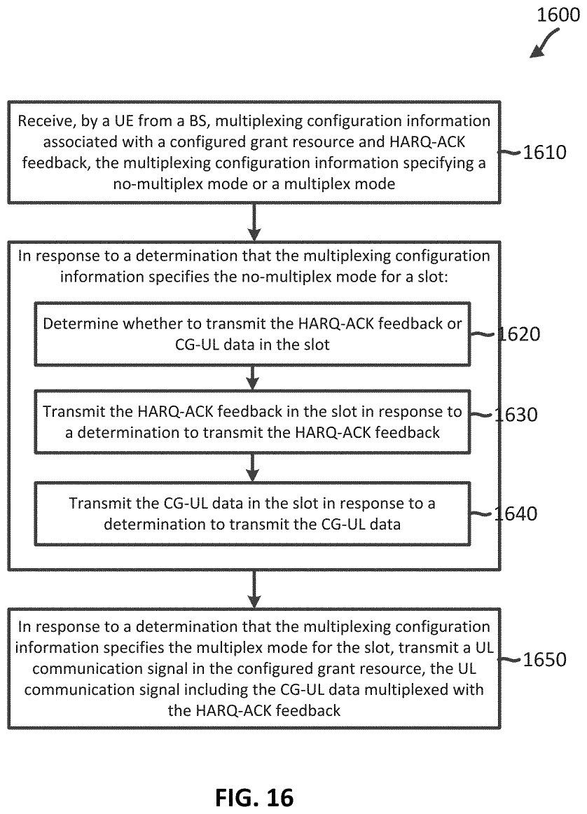

FIG. 16 is a flow diagram of a communication method 1600 according to embodiments of the present disclosure. Steps of the method 1600 can be executed by a computing device (e.g., a processor, processing circuit, and/or other suitable component) of a wireless communication device, such as the UEs 115 and 1000. In some examples, UE 115 and the UE 1000 may utilize one or more components, such as the processor 1002, the memory 1004, the configuration grant module 1008, the communication module 1009, the transceiver 1010, and/or the antennas 1016 to execute the steps of method 1000. The method 1600 may employ similar mechanisms as in the scheduling/configuration timeline 200 in FIG. 2, the timing diagram in FIG. 3, the communication scheme 400 in FIG. 4, the communication scheme 500 in FIG. 5, the communication scheme 600 in FIG. 6, the communication scheme 700 in FIG. 7, the communication scheme 800 in FIG. 8, and/or the transmission scheme 900 in FIG. 9. As illustrated, the method 1600 includes a number of enumerated steps, but embodiments of the method 1600 may include additional steps before, after, and in between the enumerated steps. In some embodiments, one or more of the enumerated steps may be omitted or performed in a different order.

At step 1610, the method 1600 includes receiving, by a UE from a BS, multiplexing configuration information associated with a configured grant resource and HARQ-ACK feedback, the multiplexing configuration information specifying a no-multiplex mode or a multiplex mode. In response to a determination that the multiplexing configuration information specifies the no-multiplex mode for a slot, steps 1620, 1630, and 1640 may be executed. At step 1620, the method 1600 includes determining whether to transmit the HARQ-ACK feedback or CG-UL data in the slot. At step 1630, the method 1600 includes transmitting the HARQ-ACK feedback in the slot in response to a determination to transmit the HARQ-ACK feedback. At step 1640, the method 1600 includes transmitting the CG-UL data in the slot in response to a determination to transmit the CG-UL data. At step 1650, the method 1600 includes in response to a determination that the multiplexing configuration information specifies the multiplex mode for the slot, transmitting a UL communication signal in the configured grant resource, the UL communication signal including the CG-UL data multiplexed with the HARQ-ACK feedback.

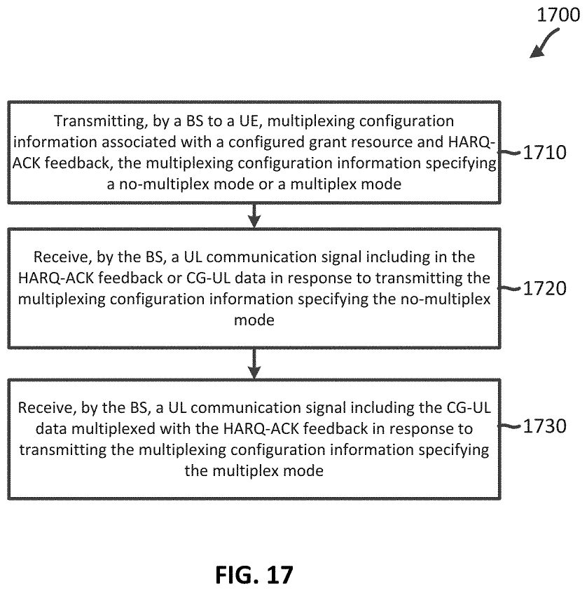

FIG. 17 is a flow diagram of a communication method 1700 according to embodiments of the present disclosure. Steps of the method 1700 can be executed by a computing device (e.g., a processor, processing circuit, and/or other suitable component) of a wireless communication device, such as the UEs 115 and 1000. In some examples, BS 105 and the BS 1100 may utilize one or more components, such as the processor 1102, the memory 1104, the configuration grant module 1108, the communication module 1109, the transceiver 1110, and/or the antennas 1116 to execute the steps of method 1700. The method 1700 may employ similar mechanisms as in the scheduling/configuration timeline 200 in FIG. 2, the timing diagram in FIG. 3, the communication scheme 400 in FIG. 4, the communication scheme 500 in FIG. 5, the communication scheme 600 in FIG. 6, the communication scheme 700 in FIG. 7, the communication scheme 800 in FIG. 8, and/or the transmission scheme 900 in FIG. 9. As illustrated, the method 1700 includes a number of enumerated steps, but embodiments of the method 1700 may include additional steps before, after, and in between the enumerated steps. In some embodiments, one or more of the enumerated steps may be omitted or performed in a different order.

At step 1710, the method 1700 includes transmitting, by a BS to a UE, multiplexing configuration information associated with a configured grant resource and HARQ-ACK feedback, the multiplexing configuration information specifying a no-multiplex mode or a multiplex mode. At step 1720, the method 1700 includes receiving, by the BS, a UL communication signal including the HARQ-ACK feedback or CG-UL data in response to transmitting the multiplexing configuration information specifying the no-multiplex mode. At step 1730, the method 1700 includes receiving, by the BS, a UL communication signal including the CG-UL data multiplexed with the HARQ-ACK feedback in response to transmitting the multiplexing configuration information specifying the multiplex mode.

In an example, the BS may switch the multiplexing configuration information from the no-multiplex mode to the multiplex mode. In another example, the BS may switch the multiplexing configuration information from the multiplex mode to the no-multiplex mode.

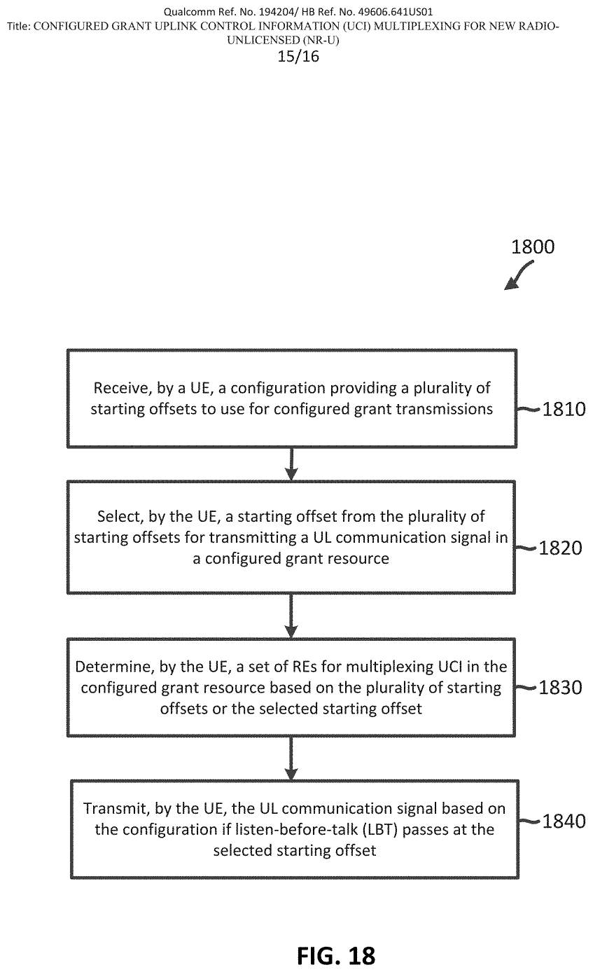

FIG. 18 is a flow diagram of a communication method 1800 according to embodiments of the present disclosure. Steps of the method 1800 can be executed by a computing device (e.g., a processor, processing circuit, and/or other suitable component) of a wireless communication device, such as the UEs 115 and 1000. In some examples, UE 115 and the UE 1000 may utilize one or more components, such as the processor 1002, the memory 1004, the configuration grant module 1008, the communication module 1009, the transceiver 1010, and/or the antennas 1016 to execute the steps of method 1000. The method 1800 may employ similar mechanisms as in the scheduling/configuration timeline 200 in FIG. 2, the timing diagram in FIG. 3, the communication scheme 400 in FIG. 4, the communication scheme 500 in FIG. 5, the communication scheme 600 in FIG. 6, the communication scheme 700 in FIG. 7, the communication scheme 800 in FIG. 8, and/or the transmission scheme 900 in FIG. 9. As illustrated, the method 1800 includes a number of enumerated steps, but embodiments of the method 1800 may include additional steps before, after, and in between the enumerated steps. In some embodiments, one or more of the enumerated steps may be omitted or performed in a different order.

At step 1810, the method 1800 includes receiving, by a UE, a configuration providing a plurality of starting offsets to use for configured grant transmissions. At step 1820, the method 1800 includes selecting, by the UE, a starting offset from the plurality of starting offsets for transmitting a UL communication signal in a configured grant resource. At step 1830, the method 1800 includes determining a set of REs for multiplexing UCI in the configured grant resource based on the plurality of starting offsets or the selected starting offset. At step 1840, the method 1800 includes transmitting the UL communication signal based on the configuration if LBT passes at the selected starting offset.

In some examples, determining the set of REs includes determining a starting symbol to use for multiplexing the UL UCI. In an example, the starting symbol may be a first full symbol after the starting offset. In another example, the starting symbol is a first full symbol after a largest starting offset of the plurality of starting offsets. In some examples, an allowed starting symbol for a given starting offset may be different for each UCI of a plurality of UCI.

In an example, determining the set of REs includes determining a number of REs to use for multiplexing the UCI. In another example, determining the set of REs includes determining the set of REs based on at least one of a number of physical uplink shared channel (PUSCH) data symbols allocated independent from the starting offset, a number of full PUSCH data symbols used based on an actual starting offset used by the UE, or a number of full PUSCH data symbols that can be used based on a largest starting offset of the plurality of starting offsets. A number of PUSCH symbols considered for a number of REs of the set of REs for a given starting offset may be different for a first UCI than a second UCI. The first UCI and the second UCI may be any UCI discussed in the present disclosure.

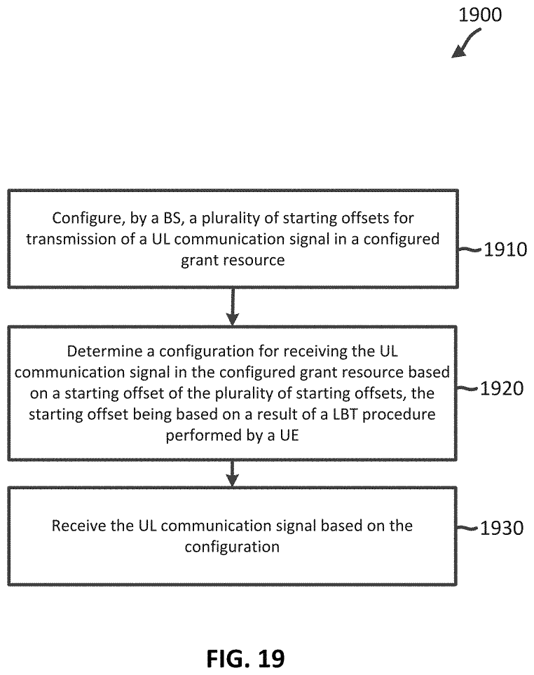

FIG. 19 is a flow diagram of a communication method 1900 according to embodiments of the present disclosure. Steps of the method 1900 can be executed by a computing device (e.g., a processor, processing circuit, and/or other suitable component) of a wireless communication device, such as the BSs 105 and 1100. In some examples, BS 105 and the BS 1100 may utilize one or more components, such as the processor 1102, the memory 1104, the configuration grant module 1108, the communication module 1109, the transceiver 1110, and/or the antennas 1116 to execute the steps of method 1900. The method 1900 may employ similar mechanisms as in the scheduling/configuration timeline 200 in FIG. 2, the timing diagram in FIG. 3, the communication scheme 400 in FIG. 4, the communication scheme 500 in FIG. 5, the communication scheme 600 in FIG. 6, the communication scheme 700 in FIG. 7, the communication scheme 800 in FIG. 8, and/or the transmission scheme 900 in FIG. 9. As illustrated, the method 1900 includes a number of enumerated steps, but embodiments of the method 1900 may include additional steps before, after, and in between the enumerated steps. In some embodiments, one or more of the enumerated steps may be omitted or performed in a different order.

At step 1910, the method 190 includes configuring, by a base station (BS), a plurality of starting offsets for transmission of an UL communication signal in a configured grant resource. At step 1920, the method 1900 includes determining a configuration for receiving the UL communication signal in the configured grant resource based on a starting offset of the plurality of starting offsets, the starting offset being based on a result of a LBT procedure performed by a UE. At step 1930, the method 1900 includes receiving the UL communication signal based on the configuration.

Information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

The various illustrative blocks and modules described in connection with the disclosure herein may be implemented or performed with a general-purpose processor, a DSP, an ASIC, an FPGA or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described above can be implemented using software executed by a processor, hardware, firmware, hardwiring, or combinations of any of these. Features implementing functions may also be physically located at various positions, including being distributed such that portions of functions are implemented at different physical locations. Also, as used herein, including in the claims, “or” as used in a list of items (for example, a list of items prefaced by a phrase such as “at least one of” or “one or more of”) indicates an inclusive list such that, for example, a list of [at least one of A, B, or C] means A or B or C or AB or AC or BC or ABC (i.e., A and B and C).

As those of some skill in this art will by now appreciate and depending on the particular application at hand, many modifications, substitutions and variations can be made in and to the materials, apparatus, configurations and methods of use of the devices of the present disclosure without departing from the spirit and scope thereof. In light of this, the scope of the present disclosure should not be limited to that of the particular embodiments illustrated and described herein, as they are merely by way of some examples thereof, but rather, should be fully commensurate with that of the claims appended hereafter and their functional equivalents.

What is claimed is:

1. A method of wireless communication, comprising:
receiving, by a user equipment (UE), a configuration for a configured grant resource, the configuration indicating whether to multiplex a configured-grant uplink control information (CG-UCI) and Hybrid Automatic Repeat Request-acknowledgement (HARQ-ACK) in the configured grant resource; and
transmitting, by the UE, an uplink (UL) communication signal in the configured grant resource, the UL communication signal including the CG-UCI and the HARQ-ACK multiplexed with UL data if the configuration includes an indication to multiplex the CG-UCI and the HARQ-ACK in the configured grant resource.

2. The method of claim 1, wherein the HARQ-ACK is scheduled at a time resource overlapping with the configured grant resource.

3. The method of claim 1, wherein the UL communication signal includes the CG-UCI and is devoid of the HARQ-ACK if the configuration includes an indication not to multiplex the CG-UCI and the HARQ-ACK in the configured grant resource, wherein the HARQ-ACK is not scheduled at a time resource overlapping with the configured grant resource.

4. The method of claim 1, wherein the UL communication signal includes the CG-UCI and is devoid of the HARQ-ACK if the configuration includes an indication to multiplex the CG-UCI and the HARQ-ACK in the configured grant resource, and wherein the HARQ-ACK is not scheduled at a time resource overlapping with the configured grant resource.

5. The method of claim 1, wherein the UL communication signal includes the HARQ-ACK and is devoid of a configured grant-physical uplink shared channel (CG-PUSCH) if the configuration includes an indication not to multiplex the CG-UCI and the HARQ-ACK in the configured grant resource, wherein the HARQ-ACK is scheduled at a time resource overlapping with the configured grant resource.

6. The method of claim 1, wherein the configuration is a radio resource control (RRC) configuration.

7. A method of wireless communication, comprising:
receiving, by a user equipment (UE), a transmission configuration for a configured grant resource; and
transmitting, by the UE, an uplink (UL) communication signal in the configured grant resource, the UL communication signal including at least one of a scheduled Hybrid Automatic Repeat Request (HARQ) acknowledgment (ACK)/negative-acknowledgement (NACK) or a configured grant transmission, wherein the HARQ ACK/NACK is associated with a first beta offset, the CG-UCI is associated with a second beta offset, and the first beta offset is different from the second beta offset.

8. The method of claim 7, wherein the configured grant transmission includes configured-grant UL control information (CG-UCI).

9. The method of claim 7, wherein transmitting the UL communication signal includes:
multiplexing CG-UCI using multiplexing procedures for HARQ-ACK/NACK UCI.

10. The method of claim 7, wherein the UL communication signal includes the scheduled HARQ ACK/NACK and is devoid of the configured grant transmission.

11. The method of claim 7, wherein the configured grant transmission includes configured-grant physical UL shared channel (CG-PUSCH).

12. The method of claim 7, wherein transmitting the UL communication signal includes:
transmitting CG-UCI as part of a HARQ-ACK UCI payload.

13. The method of claim 7, wherein receiving the transmission configuration includes:
receiving a radio resource control (RRC) message indicating the configured grant resource.

14. The method of claim 7, wherein transmitting the UL communication signal includes:
determining that no HARQ ACK/NACK is to be transmitted in the UL communication signal; and
transmitting the configuration grant transmission in response to a determination that no HARQ ACK/NACK is to be transmitted in the UL communication signal.

15. The method of claim 7, wherein the UL communication signal includes the configured grant transmission and is devoid of the HARQ ACK/NACK.

16. An apparatus, comprising:
a transceiver configured to:
receive a configuration for a configured grant resource, wherein the configuration indicates whether to multiplex a configured-grant uplink control information (CG-UCI) and Hybrid Automatic Repeat Request-acknowledgement (HARQ-ACK) in the configured grant resource; and
transmit an uplink (UL) communication signal in the configured grant resource, wherein the UL communication signal includes the CG-UCI and the HARQ-ACK multiplexed with UL data if the configuration includes an indication to multiplex the CG-UCI and the HARQ-ACK in the configured grant resource.

17. The apparatus of claim 16, wherein the HARQ-ACK is scheduled at a time resource overlapping with the configured grant resource.

18. The apparatus of claim 16, wherein the UL communication signal includes the CG-UCI and is devoid of the HARQ-ACK if the configuration includes an indication not to multiplex the CG-UCI and the HARQ-ACK in the configured grant resource.

19. The apparatus of claim 18, wherein the HARQ-ACK is not scheduled at a time resource overlapping with the configured grant resource.

20. The apparatus of claim 16, wherein the UL communication signal includes the HARQ-ACK and is devoid of a configured grant-physical uplink shared channel (CG-PUSCH) if the configuration includes an indication not to multiplex the CG-UCI and the HARQ-ACK in the configured grant resource.

21. The apparatus of claim 20, wherein the HARQ-ACK is scheduled at a time resource overlapping with the configured grant resource.

22. An apparatus, comprising:
a transceiver configured to:
receive a transmission configuration for a configured grant resource; and
transmit an uplink (UL) communication signal in the configured grant resource, wherein the UL communication signal includes at least one of a scheduled Hybrid Automatic Repeat Request (HARQ) acknowledgment (ACK)/negative-acknowledgement (NACK) or a configured grant transmission, wherein the HARQ ACK/NACK is associated with a first beta offset, the configured grant transmission is associated with a second beta offset, and the first beta offset is different from the second beta offset.

23. The apparatus of claim 22, wherein the configured grant transmission includes at least one of configured-grant UL control information (CG-UCI) or configured-grant physical UL shared channel (CG-PUSCH).

24. The apparatus of claim 22, wherein the transceiver is configured to:
multiplex CG-UCI using multiplexing procedures for HARQ-ACK/NACK UCI.

25. The apparatus of claim 22, wherein the UL communication signal includes the scheduled HARQ ACK/NACK and is devoid of the configured grant transmission.

26. The apparatus of claim 22, wherein the transceiver is configured to:
transmit CG-UCI as part of a HARQ-ACK UCI payload.

27. The apparatus of claim 22, further comprising:
a processor configured to determine that no HARQ ACK/NACK is to be transmitted in the UL communication signal; and
wherein the transceiver is configured to transmit the configuration grant transmission in response to a determination that no HARQ ACK/NACK is to be transmitted in the UL communication signal.
